(19) United States
(12) Patent Application Publication
(10) Pub. No.: US 2026/0135941 A1
(43) Pub. Date: May 14, 2026

(54) SYSTEMS AND METHODS FOR FACILITATING COLLABORATION ON A MAP

(71) Applicant: Spencer N. Muratides, Tampa, FL (US)

(72) Inventor: Spencer N. Muratides, Tampa, FL (US)

(21) Appl. No.: 19/058,078

(22) Filed: Feb. 20, 2025

Related U.S. Application Data
(60) Provisional application No. 63/719,927, filed on Nov. 13, 2024.

(51) Int. Cl. H04M 1/72436; H04L 51/18; H04L 51/216; H04L 51/222; H04L 51/52

(52) U.S. Cl. CPC H04M 1/72436; H04L 51/18; H04L 51/216; H04L 51/222; H04L 51/52; H04M 2201/42

(57) ABSTRACT

Systems, methods, and non-transient computer readable storage medium storing instructions that are executable to perform methods for facilitating collaboration on a map are provided. The system includes computer processors and non-transient memory devices storing computer executable instructions executable by the processor devices. A selection of a map location and a first message identifying a target recipient is received from a user and displayed and/or otherwise highlighted relative to the map displayed on the screen of an electronic device. The first message is linked with the selected location and is transmitted to server devices. A reply message is received from the targeted recipient and is stitched with the first message linked with the selected map location as a first dialog thread linked with the selected map location.

### CROSS-REFERENCE TO RELATED APPLICATIONS

This application claims the benefit of U.S. Provisional Patent Application Ser. No. 63/719,927, filed Nov. 13, 2024.

### FIELD OF THE DISCLOSURE

The present disclosure relates to communication systems and methods for assisting users collaborate and manage workflows on a map. Although the embodiments herein will be described in connection with systems and methods for facilitating the management of workflows and relationships between the users relative to locations on a map for purposes of real estate development collaboration, it is to be appreciated that the embodiments have broader application such as for social collaboration on a map, governmental collaboration on a map, commercial and residential relationship management on a map, insurance relationship management on a map, real estate brokerage management on a map, and the like.

### BACKGROUND

Modern navigation technology has become part of everyday life and is widely used in a variety of industries to improve efficiency and accuracy. Global Navigation Satellite System (GNSS) is an umbrella term that covers all global satellite positioning systems (GPSs). GPS is the most widely used GNSS system in the world, originally developed for military use but now accessible to civilians.

Recent advancements in computing technology have led to the creation of Internet-connected devices that have adopted this navigation technology. As an example, an indication may be provided to device users of a location of the device on a map.

As the number and type of network-connected computing devices has increased so too has the number and variety of applications that may be used on devices that utilize this navigation technology. Many currently available applications are compatible with these network-connected computing devices whereby users' locations may be shared such as by “pin drops” or by being embedded in posts communicated between users. Traditional devices that are connected via telephony and the Intranet (e.g. email) now include location sharing and location information.

Some platforms provide social media services for networking with friends and associates including providing messaging together with information on where a particular friend is located. Also some systems are configured to display by use of “pin” images or the like where friends are located, where friends were previously located, where posts on a network are made, where posts associated with locations are made, and the like.

While it is interesting to share map location pins with friends and associates, and to engage in social networking and other communication activities with friends and associates having location information available, these systems utilize the map location information only as a secondary consideration. That is, the users' network circle of connections are used as the fundamental basis for conducting and utilizing the social interactions.

Some users, however, are particularly interested in information relating to property, real estate, land development, and the like. While these users find such social media platforms to be useful for corresponding with friends and colleagues on a casual or social level, they also consider these tools to be cumbersome to use in practice since they are rooted in the colleague, client, and customer plane or level, rather than being geographically based.

Given the above, therefore, there is a need in the art for a system that uses geographical or land-based information as a fundamental basis or datum for sharing information and making, utilizing, and maintaining social, commercial, and other connections and interaction threads.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The implementations herein provide systems and methods for facilitating collaboration and workflow management on a map.

In accordance with some aspects, systems and methods are provided that use geographical or land-based information as a fundamental basis or datum for facilitating collaboration on a map such as for example sharing information on a map, and making, utilizing, and maintaining social, commercial, and other connections and interaction threads on a map.

In accordance with some further aspects, systems and methods are provided that use geographical or land-based information as a fundamental basis or datum for facilitating workflow management on a map such as for example facilitating management of communication between users of the system, management of tasks between and/or amongst the users, and the like, on a map.

In accordance with some further aspects, systems and methods are provided that use geographical or land-based information as a fundamental basis or datum for facilitating workflow management on a map such as for example facilitating management of communication between users of the system and one or more non-users of the system, management of tasks between and/or amongst the users and/or non-users, and the like, on a map.

In accordance with some further aspects, systems and methods are provided that use geographical or land-based information as a fundamental basis or datum for facilitating workflow management on a map such as for example facilitating management of communication between one or more non-users of the system, management of tasks between and/or amongst the users and/or the non-users, and the like, on a map.

In accordance with an aspect herein, a system facilitating collaboration on a map is provided. The system includes one or more computer processors, and one or more non-transient memory devices operatively coupled with the one or more computer processors, wherein the one or more non-transient memory devices store computer executable instructions that when executed by the one or more computer processor devices cause the system to facilitate the collaboration on the map. The executable instructions comprise a map module, a user communication manager module, a linking module, a network communication manager module, and a communication thread stitching module. The map module is executable by the one or more computer processor devices to cause the system to display a map on a screen of an electronic device, receive a selection of a first location of the map from a user of the electronic device, and display and/or otherwise highlight the selected first location relative to the map displayed on the screen of the electronic device. The user communication manager module is executable by the one or more computer processor devices to cause the system to receive a first tendered message from the user in association with the selected first location being displayed on the screen, wherein the first tendered message identifies a targeted recipient. The linking module is executable by the one or more computer processor devices to cause the system to link the first tendered message with the selected first location. The network communication manager module is executable by the one or more computer processor devices to cause the system to transmit the first tendered message received from the user to one or more server devices that may be of an associated network in operative communication with the system, and receive via the one or more server devices of the associated network a first reply message from the targeted recipient in reply to the first tendered message. The communication thread stitching module is executable by the one or more computer processor devices to cause the system to associate the first reply message received from the targeted recipient with the first tendered message and, based on associating the first reply message with the first tendered message, stitch the first reply message with the first tendered message linked with the selected first location as a first dialog thread linked with the selected first location.

In accordance with any of the implementations, the map module of the system facilitating collaboration on a map is executable by the one or more computer processor devices to cause the system to display the first dialog thread comprising the first reply message stitched with the first tendered message on the screen of the electronic device in association with the selected first location being displayed on the screen of the electronic device.

In accordance with any of the implementations, the communication thread stitching module of the system facilitating collaboration on a map is executable by the one or more computer processor devices to cause the system to determine one or more other dialog threads linked with the selected first location, wherein the one or more other dialog threads comprise one or more communications related to the selected first location between one or more other users of the system different than the user of the system. The map module of the system is executable by the one or more computer processor devices to cause the system to display on the screen of the electronic device the one or more other dialog threads in association with the selected first location being displayed on the screen of the electronic device.

In accordance with any of the implementations, the map module of the system facilitating collaboration on a map is executable by the one or more computer processor devices to cause the system to receive a selection of a second location of the map from the user of the electronic device, and display the selected second location on the screen of the electronic device. The communication thread stitching module of the system is executable by the one or more computer processor devices to cause the system to determine one or more other dialog threads linked with the selected second location, wherein the one or more other dialog threads comprise one or more communications related to the selected second location between one or more other users of the system different than the user of the system. The map module of the system is executable by the one or more computer processor devices to cause the system to display on the screen of the electronic device the one or more other dialog threads in association with the selected second location being displayed on the screen of the electronic device.

In accordance with any of the implementations, the user communication manager module of the system facilitating collaboration on a map is executable by the one or more computer processor devices to cause the system to receive the first tendered message from the user in association with the selected first location being displayed on the screen as a first tendered message comprising a tag that identifies the targeted recipient, wherein the tag comprises one or more of a system username that identifies the targeted recipient, an email contact address that identifies the targeted recipient, a cellular phone contact number that identifies the targeted recipient, and/or a social media contact character set that identifies the targeted recipient. The network communication manager module of the system is executable by the one or more computer processor devices to cause the system to select an associated network in operative communication with the system based on the tag comprising the one or more of the system username, the email contact address, the cellular phone contact number, and/or the a social media contact character set, and transmit the first tendered message to one or more server devices of the selected associated network.

In accordance with any of the implementations, the user communication manager module of the system facilitating collaboration on a map is executable by the one or more computer processor devices to cause the system to receive the first tendered message from the user in association with the selected first location being displayed on the screen, wherein the first tendered message comprises a user group name that identifies a plurality of targeted recipients that are associated as members of a first user group having the name. The network communication manager module of the system is executable by the one or more computer processor devices to cause the system to transmit the first tendered message comprising the user group name received from the user to one or more server devices of an associated network in operative communication with the system, and receive via the one or more server devices of the associated network a plurality of first reply messages from the plurality of targeted recipient members of the first group having the name in reply to the first tendered message. The communication thread stitching module of the system is executable by the one or more computer processor devices to cause the system to associate the plurality of first reply messages received from the plurality of targeted recipients with the first tendered message, and based on associating each of the plurality of first reply messages with the first tendered message, stitch each of the plurality of first reply messages with the first tendered message linked with the selected first location as a first group dialog thread linked with the selected first location.

In accordance with any of the implementations, the user communication manager module of the system facilitating collaboration on a map is executable by the one or more computer processor devices to cause the system to receive the first tendered message from the user in association with the selected first location being displayed on the screen, wherein the first tendered message comprises a private user group name that identifies a plurality of targeted private group recipients that are associated as members of a first private user group having the private user group name. The network communication manager module of the system is executable by the one or more computer processor devices to cause the system to receive via the one or more server devices of the associated network a plurality of first reply messages from the targeted private group of recipients in reply to the first tendered message. The communication thread stitching module of the system is executable by the one or more computer processor devices to cause the system to associate the plurality of first reply messages received from the targeted group of recipients with the first tendered message, and based on associating each of the plurality of first reply messages with the first tendered message, stitch each of the plurality of first reply messages with the first tendered message linked with the selected first location as a first private group dialog thread linked with the selected first location. The map module of the system is executable by the one or more computer processor devices to cause the system to prevent displaying on the screen of the electronic device the first private group dialog thread to users of the system other than users identified by the private user group name as being members of the targeted private group of recipients.

In accordance with any of the implementations, the map module of the system facilitating collaboration on a map is executable by the one or more computer processor devices to cause the system to receive a selection of a second location of the map from the user of the electronic device, and highlight the selected second location relative to the map displayed on the screen of the electronic device. The user communication manager module of the system is executable by the one or more computer processor devices to cause the system to receive a second tendered message from the user in association with the selected second location being displayed on the screen, wherein the second tendered message comprises user profile information data associated with the user, wherein the user profile information data is representative of profile information of the user. The linking module of the system is executable by the one or more computer processor devices to cause the system to link the second tendered message comprising the user profile information data with the selected second location.

In accordance with any of the implementations, the map module of the system facilitating collaboration on a map is executable by the one or more computer processor devices to cause the system to receive a selection of the second location of the map from a second user of the electronic device, highlight the selected second location relative to the map displayed on the screen of the electronic device, and display the user profile information data linked with the selected second location on the screen of the electronic device.

In accordance with an aspect herein, a method of facilitating collaboration on a map is provided. The method includes one or more of displaying a map on a screen of an electronic device comprising one or more computer processors and one or more non-transient memory devices operatively coupled with the one or more computer processors, receiving from a user of the electronic device a selection of a first location on the map, displaying the selected first location on the screen of the electronic device, receiving a first tendered message from the user in association with the selected first location being displayed on the screen, wherein the first tendered message identifies a targeted recipient, linking the first tendered message with the selected first location, transmitting the first tendered message received from the user to one or more server devices of an associated network in operative communication with the electronic device, receiving via the one or more server devices of the associated network a first reply message from the targeted recipient in reply to the first tendered message, associating the first reply message received from the targeted recipient with the first tendered message, and/or stitching based on associating the first reply message with the first tendered message the first reply message with the first tendered message linked with the selected first location as a first dialog thread linked with the selected first location.

In accordance with any of the implementations, the method of facilitating collaboration on a map further includes displaying the first dialog thread comprising the first reply message stitched with the first tendered message on the screen of the electronic device in association with the selected first location being displayed on the screen of the electronic device.

In accordance with any of the implementations, the method of facilitating collaboration on a map further includes one or more of determining one or more other dialog threads linked with the selected first location, wherein the one or more other dialog threads comprise one or more communications related to the selected first location between one or more other users of the system different than the user of the system, and/or displaying on the screen of the electronic device the one or more other dialog threads in association with the selected first location being displayed on the screen of the electronic device.

In accordance with any of the implementations, the method of facilitating collaboration on a map further includes one or more of receiving a selection of a second location on the map from the user of the electronic device, displaying the selected second location on the screen of the electronic device, determining one or more other dialog threads linked with the selected second location, wherein the one or more other dialog threads comprise one or more communications related to the selected second location between one or more other users of the system different than the user of the system, and/or displaying on the screen of the electronic device the one or more other dialog threads in association with the selected second location being displayed on the screen of the electronic device.

In accordance with any of the implementations, the method of facilitating collaboration on a map further includes one or more of receiving the first tendered message from the user in association with the selected first location being displayed on the screen as a first tendered message comprising a tag that identifies the targeted recipient, wherein the tag comprises one or more of a system username that identifies the targeted recipient, an email contact address that identifies the targeted recipient, a cellular phone contact number that identifies the targeted recipient, and/or a social media contact character set that identifies the targeted recipient, selecting an associated network in operative communication with the system based on the tag comprising the one or more of the system username, the email contact address, the cellular phone contact number, and/or the a social media contact character set, and/or transmitting the first tendered message to one or more server devices of the selected associated network.

In accordance with any of the implementations, the method of facilitating collaboration on a map further includes one or more of receiving the first tendered message from the user in association with the selected first location being displayed on the screen, wherein the first tendered message comprises a user group name that identifies a plurality of targeted recipients that are associated as members of a first user group having the name, transmitting the first tendered message comprising the user group name received from the user to one or more server devices of an associated network in operative communication with the system, receiving via the one or more server devices of the associated network a plurality of first reply messages from the plurality of targeted recipient members of the first group having the name in reply to the first tendered message, associating the plurality of first reply messages received from the plurality of targeted recipients with the first tendered message, and/or stitching, based on associating each of the plurality of first reply messages with the first tendered message, each of the plurality of first reply messages with the first tendered message linked with the selected first location as a first group dialog thread linked with the selected first location.

In accordance with any of the implementations, the method of facilitating collaboration on a map further includes one or more of receiving the first tendered message from the user in association with the selected first location being displayed on the screen, wherein the first tendered message comprises a private user group name that identifies a plurality of targeted private group recipients that are associated as members of a first private user group having the private user group name, receiving via the one or more server devices of the associated network a plurality of first reply messages from the targeted private group of recipients in reply to the first tendered message, associating the plurality of first reply messages received from the targeted group of recipients with the first tendered message, stitching, based on associating each of the plurality of first reply messages with the first tendered message, each of the plurality of first reply messages with the first tendered message linked with the selected first location as a first private group dialog thread linked with the selected first location, and/or preventing displaying on the screen of the electronic device the first private group dialog thread to users of the system other than users identified by the private user group name as being members of the targeted private group of recipients.

In accordance with any of the implementations, the method of facilitating collaboration on a map further includes one or more of receiving a selection of a second location of the map from the user of the electronic device, highlighting the selected second location relative to the map displayed on the screen of the electronic device, receiving a second tendered message from the user in association with the selected second location being displayed on the screen, wherein the second tendered message comprises user profile information data associated with the user, wherein the user profile information data is representative of profile information of the user, and/or linking link the second tendered message comprising the user profile information data with the selected second location.

In accordance with any of the implementations, the method of facilitating collaboration on a map further includes one or more of receiving a selection of the second location of the map from a second user of the electronic device, highlighting the selected second location relative to the map displayed on the screen of the electronic device, and/or displaying the user profile information data linked with the selected second location on the screen of the electronic device.

In accordance with an aspect a non-transient computer readable storage medium is provided storing one or more computer programs comprising instructions that, when executed by one or more processor devices of an associated computer system, cause the associated computer system to perform a method of facilitating collaboration on a map, the method comprising one or more of displaying a map on a screen of an electronic device comprising one or more computer processors and one or more non-transient memory devices operatively coupled with the one or more computer processors, receiving from a user of the electronic device a selection of a first location on the map, displaying the selected first location on the screen of the electronic device, receiving a first tendered message from the user in association with the selected first location being displayed on the screen, wherein the first tendered message identifies a targeted recipient, linking the first tendered message with the selected first location, transmitting the first tendered message received from the user to one or more server devices of an associated network in operative communication with the electronic device, receiving via the one or more server devices of the associated network a first reply message from the targeted recipient in reply to the first tendered message, associating the first reply message received from the targeted recipient with the first tendered message, and/or stitching, based on associating the first reply message with the first tendered message, the first reply message with the first tendered message linked with the selected first location as a first dialog thread linked with the selected first location.

In accordance with any of the implementations, the non-transient computer readable storage medium stores instructions that are executable to perform a method of facilitating collaboration on a map further by displaying the first dialog thread comprising the first reply message stitched with the first tendered message on the screen of the electronic device in association with the selected first location being displayed on the screen of the electronic device.

In accordance with any of the implementations, the non-transient computer readable storage medium stores instructions that are executable to perform a method of facilitating collaboration on a map further by one or more of determining one or more other dialog threads linked with the selected first location, wherein the one or more other dialog threads comprise one or more communications related to the selected first location between one or more other users of the system different than the user of the system, and/or displaying on the screen of the electronic device the one or more other dialog threads in association with the selected first location being displayed on the screen of the electronic device.

In accordance with any of the implementations, the non-transient computer readable storage medium stores instructions that are executable to perform a method of facilitating collaboration on a map further by one or more of receiving a selection of a second location on the map from the user of the electronic device, displaying the selected second location on the screen of the electronic device, determining one or more other dialog threads linked with the selected second location, wherein the one or more other dialog threads comprise one or more communications related to the selected second location between one or more other users of the system different than the user of the system, and/or displaying on the screen of the electronic device the one or more other dialog threads in association with the selected second location being displayed on the screen of the electronic device.

In accordance with any of the implementations, the non-transient computer readable storage medium stores instructions that are executable to perform a method of facilitating collaboration on a map further by one or more of receiving the first tendered message from the user in association with the selected first location being displayed on the screen as a first tendered message comprising a tag that identifies the targeted recipient, wherein the tag comprises one or more of a system username that identifies the targeted recipient, an email contact address that identifies the targeted recipient, a cellular phone contact number that identifies the targeted recipient, and/or a social media contact character set that identifies the targeted recipient, selecting an associated network in operative communication with the system based on the tag comprising the one or more of the system username, the email contact address, the cellular phone contact number, and/or the a social media contact character set, and/or transmitting the first tendered message to one or more server devices of the selected associated network.

In accordance with any of the implementations, the non-transient computer readable storage medium stores instructions that are executable to perform a method of facilitating collaboration on a map further by receiving the first tendered message from the user in association with the selected first location being displayed on the screen, wherein the first tendered message comprises a user group name that identifies a plurality of targeted recipients that are associated as members of a first user group having the name, transmitting the first tendered message comprising the user group name received from the user to one or more server devices of an associated network in operative communication with the system, receiving via the one or more server devices of the associated network a plurality of first reply messages from the plurality of targeted recipient members of the first group having the name in reply to the first tendered message, associating the plurality of first reply messages received from the plurality of targeted recipients with the first tendered message, and/or stitching, based on associating each of the plurality of first reply messages with the first tendered message, each of the plurality of first reply messages with the first tendered message linked with the selected first location as a first group dialog thread linked with the selected first location.

In accordance with any of the implementations, the non-transient computer readable storage medium stores instructions that are executable to perform a method of facilitating collaboration on a map further by receiving the first tendered message from the user in association with the selected first location being displayed on the screen, wherein the first tendered message comprises a private user group name that identifies a plurality of targeted private group recipients that are associated as members of a first private user group having the private user group name, receiving via the one or more server devices of the associated network a plurality of first reply messages from the targeted private group of recipients in reply to the first tendered message, associating the plurality of first reply messages received from the targeted group of recipients with the first tendered message, stitching, based on associating each of the plurality of first reply messages with the first tendered message, each of the plurality of first reply messages with the first tendered message linked with the selected first location as a first private group dialog thread linked with the selected first location, and/or preventing displaying on the screen of the electronic device the first private group dialog thread to users of the system other than users identified by the private user group name as being members of the targeted private group of recipients.

In accordance with any of the implementations, the non-transient computer readable storage medium stores instructions that are executable to perform a method of facilitating collaboration on a map further by receiving a selection of a second location of the map from the user of the electronic device, highlighting the selected second location relative to the map displayed on the screen of the electronic device, receiving a second tendered message from the user in association with the selected second location being displayed on the screen, wherein the second tendered message comprises user profile information data associated with the user, wherein the user profile information data is representative of profile information of the user, and/or linking link the second tendered message comprising the user profile information data with the selected second location.

In accordance with any of the implementations, the non-transient computer readable storage medium stores instructions that are executable to perform a method of facilitating collaboration on a map further by receiving a selection of the second location of the map from a second user of the electronic device, highlighting the selected second location relative to the map displayed on the screen of the electronic device, and/or displaying the user profile information data linked with the selected second location on the screen of the electronic device.

In accordance with an aspect herein, a system facilitating workflow management on a map is provided, wherein the system comprises one or more computer processors, and one or more non-transient memory devices operatively coupled with the one or more computer processors, the one or more non-transient memory devices storing computer executable instructions that when executed by the one or more computer processor devices cause the system to facilitate the workflow management. The executable instructions comprise a map module executable by the one or more computer processor devices to cause the system to display a map together with a set of management initiation indicia on a screen of an electronic device, and receive from a user of the electronic device a selection of a workflow management initiation indicia from among the set of management initiation indicia. The executable instructions further comprise a workflow warehousing module executable by the one or more computer processor devices to cause the system to identify a stored task item associated with the user based on the map module receiving the selection of the workflow management initiation indicia from the user. The executable instructions comprise a linking module executable by the one or more computer processor devices to cause the system to identify a location on the map previously linked by the linking module with the stored task item identified by the workflow warehousing module as being associated with the user. The map module is executable by the one or more computer processor devices to cause the system to display on the map the identified location linked with the stored task item.

In accordance with any of the implementations, the workflow warehousing module of the system facilitating workflow management on a map is executable by the one or more computer processor devices to cause the system to identify a stored project task item as the task item associated with the user, wherein the identified stored project task item is representative of an activity type of the user relative to the identified location on the map.

In accordance with any of the implementations, the map module of the system facilitating workflow management on a map is executable by the one or more computer processor devices to cause the system to display on the screen of the electronic device the identified stored project task item as a marker image overlayed on the identified location on the map.

In accordance with any of the implementations, the map module of the system facilitating workflow management on a map is executable by the one or more computer processor devices to cause the system to display on the screen of the electronic device the identified stored project task item as a marker image having a visual representation of the activity type of the identified stored project task item.

In accordance with any of the implementations, the map module of the system facilitating workflow management on a map is executable by the one or more computer processor devices to cause the system to display on the screen of the electronic device the identified stored project task item as a marker image having a different visual color and/or pattern representation of one or more of a target activity type representative of the identified location being subject of interest for sale, purchase, or lease by one or more users of the system, a prospect activity type representative of the identified location being available for purchase and/or lease, a negotiating activity type representative of the identified location being involved in ongoing sale, purchase, or lease negotiations, an active activity type representative of the identified location being under contract for sale, purchase, or lease, or under construction, and/or an archive activity type representative of the identified location being inactive relative to sale, purchase, or lease interest or activities.

In accordance with any of the implementations, the workflow warehousing module of the system facilitating workflow management on a map is executable by the one or more computer processor devices to cause the system to identify a stored messaging task item as the task item associated with the user, wherein the identified stored messaging task item is representative of a (portion of a) historical message dialog between the user of the electronic device and an associated entity relative to the identified location on the map.

In accordance with any of the implementations, the map module of the system facilitating workflow management on a map is executable by the one or more computer processor devices to cause the system to display on the screen of the electronic device the identified stored messaging task item as an image of text comprising the identified stored messaging task item in proximate association with the location on the map linked with the stored task item.

In accordance with any of the implementations, the curator warehousing module of the system facilitating workflow management on a map further comprises a curator warehousing module executable by the one or more computer processor devices to cause the system to curate the identified stored messaging task item to the user from a plurality of historical message dialogs relative to a plurality of locations on the map based on a predetermined set of parameters.

In accordance with any of the implementations, the curator warehousing module of the system facilitating workflow management on a map is executable by the one or more computer processor devices to cause the system to curate the identified stored messaging task item to the user from the plurality of historical message dialogs relative to the plurality of locations on the map based on one or more of message tagging events associated with the user, stored message reminder events associated with the user, keyword detection in the plurality of historical message dialogs, and/or an inactivity of messaging events related to the user.

In accordance with an aspect herein, a method is provided for facilitating workflow management on a map, wherein the method comprises one or more of displaying a map on a screen of an electronic device comprising one or more computer processors and one or more non-transient memory devices operatively coupled with the one or more computer processors, receiving from a user of the electronic device a selection of a workflow management initiation indicia from among the set of management initiation indicia displayed on the screen of the electronic device, identifying a stored task item associated with the user based on receiving the selection of the workflow management initiation indicia from the user, identifying a location on the map previously linked by the linking module with the stored task item identified as being associated with the user, and/or displaying on the map the identified location linked with the stored task item.

In accordance with any of the implementations, the method of facilitating workflow management on a map further includes identifying a stored project task item as the task item associated with the user, wherein the identified stored project task item is representative of an activity type of the user relative to the identified location on the map.

In accordance with any of the implementations, the method of facilitating workflow management on a map further includes displaying on the screen of the electronic device the identified stored project task item as a marker image overlayed on the identified location on the map.

In accordance with any of the implementations, the method of facilitating workflow management on a map further includes displaying on the screen of the electronic device the identified stored project task item as a marker image having a visual representation of the activity type of the identified stored project task item.

In accordance with any of the implementations, the method of facilitating workflow management on a map further includes displaying on the screen of the electronic device the identified stored project task item as a marker image having a different visual color and/or pattern representation of one or more of a target activity type representative of the identified location being subject of interest for sale, purchase, or lease by one or more users of the system, a prospect activity type representative of the identified location being available for purchase and/or lease, a negotiating activity type representative of the identified location being involved in ongoing sale, purchase, or lease negotiations, an active activity type representative of the identified location being under contract for sale, purchase, or lease, or under construction, and/or an archive activity type representative of the identified location being inactive relative to sale, purchase, or lease interest or activities.

In accordance with any of the implementations, the method of facilitating workflow management on a map further includes identifying a stored messaging task item as the task item associated with the user, wherein the identified stored messaging task item is representative of at least a portion of a historical message dialog between the user of the electronic device and an associated entity relative to the identified location on the map.

In accordance with any of the implementations, the method of facilitating workflow management on a map further includes displaying on the screen of the electronic device the identified stored messaging task item as an image of text comprising the identified stored messaging task item in proximate association with the location on the map linked with the stored task item.

In accordance with any of the implementations, the method of facilitating workflow management on a map further includes curating the identified stored messaging task item to the user from a plurality of historical message dialogs relative to a plurality of locations on the map based on a predetermined set of parameters.

In accordance with any of the implementations, the method of facilitating workflow management on a map further includes curating the identified stored messaging task item to the user from the plurality of historical message dialogs relative to the plurality of locations on the map based on one or more of message tagging events associated with the user, stored message reminder events associated with the user, keyword detection in the plurality of historical message dialogs, and/or an inactivity of messaging events related to the user.

In an aspect, a non-transient computer readable storage medium is provided storing one or more computer programs comprising instructions that, when executed by one or more processor devices of an associated computer system, cause the associated computer system to perform a method of facilitating workflow management on a map, the method comprising one or more of displaying a map on a screen of an electronic device comprising one or more computer processors and one or more non-transient memory devices operatively coupled with the one or more computer processors, receiving from a user of the electronic device a selection of a workflow management initiation indicia from among the set of management initiation indicia displayed on the screen of the electronic device, identifying a stored task item associated with the user based on receiving the selection of the workflow management initiation indicia from the user, identifying a location on the map previously linked by the linking module with the stored task item identified as being associated with the user, and/or displaying on the map the identified location linked with the stored task item.

In accordance with any of the implementations, the non-transient computer readable storage medium stores instructions that are executable to perform a method of facilitating workflow management on a map further by identifying a stored project task item as the task item associated with the user, wherein the identified stored project task item is representative of an activity type of the user relative to the identified location on the map.

In accordance with any of the implementations, the non-transient computer readable storage medium stores instructions that are executable to perform a method of facilitating workflow management on a map further by displaying on the screen of the electronic device the identified stored project task item as a marker image overlayed on the identified location on the map.

In accordance with any of the implementations, the non-transient computer readable storage medium stores instructions that are executable to perform a method of facilitating workflow management on a map further by displaying on the screen of the electronic device the identified stored project task item as a marker image having a visual representation of the activity type of the identified stored project task item.

In accordance with any of the implementations, the non-transient computer readable storage medium stores instructions that are executable to perform a method of facilitating workflow management on a map further by displaying on the screen of the electronic device the identified stored project task item as a marker image having a different visual color and/or pattern representation of one or more of a target activity type representative of the identified location being subject of interest for sale, purchase, or lease by one or more users of the system, a prospect activity type representative of the identified location being available for purchase and/or lease, a negotiating activity type representative of the identified location being involved in ongoing sale, purchase, or lease negotiations, an active activity type representative of the identified location being under contract for sale, purchase, or lease, or under construction, and/or an archive activity type representative of the identified location being inactive relative to sale, purchase, or lease interest or activities.

In accordance with any of the implementations, the non-transient computer readable storage medium stores instructions that are executable to perform a method of facilitating workflow management on a map further by identifying a stored messaging task item as the task item associated with the user, wherein the identified stored messaging task item is representative of at least a portion of a historical message dialog between the user of the electronic device and an associated entity relative to the identified location on the map.

In accordance with any of the implementations, the non-transient computer readable storage medium stores instructions that are executable to perform a method of facilitating workflow management on a map further by displaying on the screen of the electronic device the identified stored messaging task item as an image of text comprising the identified stored messaging task item in proximate association with the location on the map linked with the stored task item.

In accordance with any of the implementations, the non-transient computer readable storage medium stores instructions that are executable to perform a method of facilitating workflow management on a map further by curating the identified stored messaging task item to the user from a plurality of historical message dialogs relative to a plurality of locations on the map based on a predetermined set of parameters.

In accordance with any of the implementations, the non-transient computer readable storage medium stores instructions that are executable to perform a method of facilitating workflow management on a map further by curating the identified stored messaging task item to the user from the plurality of historical message dialogs relative to the plurality of locations on the map based on one or more of message tagging events associated with the user, stored message reminder events associated with the user, keyword detection in the plurality of historical message dialogs, and/or an inactivity of messaging events related to the user.

Other embodiments, features and advantages of the example embodiments and implementations for facilitating collaboration and workflow management on a map will become apparent from the following description of the embodiments, taken together with the accompanying drawings, which illustrate, by way of example, the principles of the example embodiments.

### BRIEF DESCRIPTION OF THE DRAWINGS

In the accompanying drawings which are incorporated in and constitute a part of the specification, example embodiments of the implementations are illustrated, which, together with a general description of the implementations given above, and the detailed description given below, serve to exemplify the example embodiments of the claimed invention.

FIG. 1 is a schematic view of an environment in which the disclosed system and method for facilitating relationship management, collaboration, and workflow management on a map may be implemented.

FIG. 2 is a block diagram of an example computing environment suitable for implementing an electronic user device and/or a server device in accordance with various example embodiments.

FIG. 3 is a block diagram representation of computer-executable instructions organized into one or more computer-executable components or modules in accordance with an example embodiment.

FIG. 4 illustrates an example of a user interface displaying a map in accordance with an example embodiment.

FIG. 5 illustrates an example of a user interface displaying collaboration facilitation on a map in accordance with an example embodiment.

FIG. 6 illustrates an example of a user interface displaying collaboration facilitation on a map between multiple users in accordance with an example embodiment.

FIG. 7 illustrates an example of a user interface displaying collaboration facilitation on a map including live information feeds between multiple users in accordance with an example embodiment.

FIG. 8 illustrates an example of a user interface displaying collaboration facilitation on a map including support of plural tagging modalities.

FIGS. 9 and 10 illustrate an example of a user interface and network system displaying collaboration facilitation on a map including support of linking plural tagging modalities to locations on a map.

FIG. 11 is a schematic view showing an example of information collaboration on a map in accordance with an example embodiment.

FIG. 12 is a schematic view showing a further example of information collaboration using location layers on a map in accordance with an example embodiment.

FIG. 13 is a schematic view showing a further example of information collaboration using location layers, a timeline, and specific user tenants on a map in accordance with an example embodiment.

FIG. 14 is a schematic view showing a further example of information collaboration using location markup layers, and a timeline on a map in accordance with an example embodiment.

FIG. 15 is a schematic representation of layers of messages and other information that may be stitched together and linked to various locations for collaboration on a map.

FIG. 16 shows an example of a user interface illustrating system support of linking or otherwise tying user profiles to locations on a map.

FIG. 17 illustrates an example of a method for facilitating collaboration on a map in accordance with an example embodiment.

FIGS. 18A-18E show example user interfaces illustrating system support of workflow management on a map in accordance with an example embodiment.

FIG. 19 shows an example of a user interface illustrating system support of filtering workflow management on a map in accordance with an example embodiment.

FIGS. 20A and 20B show example user interfaces illustrating system support of project and pipeline workflow management on a map in accordance with an example embodiment.

FIG. 21 shows an example of a user interface illustrating system support of filtering and reminder workflow management on a map in accordance with an example embodiment.

FIGS. 22A and 22B show example user interfaces illustrating system support of public and private publication of user profiles linked to locations on a map in accordance with an example embodiment.

FIG. 23A shows an example of a user interface illustrating system support of public and private publication of user profiles linked to locations on a map based on either of the interfaces of FIG. 22A or 22B in accordance with an example embodiment.

FIG. 23B shows an example of a user interface based on the interface of FIG. 23A illustrating stitched conversation threads having different mutual interaction authorization capabilities linked to a location on a map.

FIG. 24 illustrates an example of a method for facilitating workflow management on a map in accordance with an example embodiment.

### DETAILED DESCRIPTION

The following describes one or more example embodiments of the disclosed systems and methods, as shown in the accompanying figures of the drawings described briefly above. Various modifications to the example embodiments may be contemplated by one of skill in the art.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” or “one or more of A, B, and/or C” indicates the possibilities of only A, only B, only C, or any combination of two or more of A, B, and C (e.g., A and B; B and C; A and C; or A, B, and C).

The following describes one or more example implementations of the disclosed system and method for facilitating communication, collaboration, and relationship management on a map, as shown in the accompanying figures of the drawings described briefly above. Generally, the disclosed systems and methods provide for improved communication and relationship management efficiency relative to maps as compared to conventional systems that are not map based.

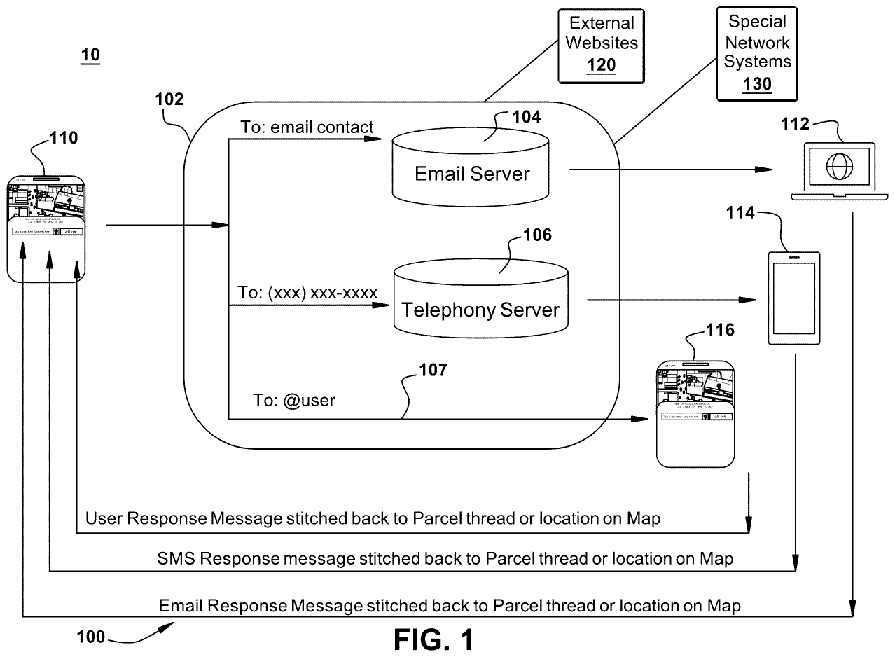

FIG. 1 is an example environment 10 in which systems 100 and methods providing relationship management, collaboration, and workflow management on a map may be implemented. The elements of environment 10 may wirelessly communicate with one another in any suitable manner, including directly (e.g., via Bluetooth, radio frequency signals, or the like) or via communication network 102 (e.g. REST, HTTP, Websockets, TCP, UDP, RTP, or the like). For example, communication network 102 may utilize one or more of various communication techniques or mechanisms, including radio frequency, Wi-Fi, cellular, or the like. In an embodiment the information transmissions may be from multiple sources. The multiple sources may be different networks or different means of communication. The means of communication is flexible and can support various communication protocols and devices, making it suitable for multiple applications across different industries. Protocols may include SMS, fax, email, instant message, internet protocol, voice, voicemail, GPRS, CDMA, WAP protocol, internet, text, chat, AR gestures, transportation device integration, and others.

System 100 includes one or more user devices 110, 112, 114, and 116, one or more websites 120, and one or more social networking systems 130, as well as the network 102 enabling these systems and devices to communicate. The websites 120 are shown in the Figure in a single block representation for ease of illustration only, and it is to be appreciated that the system 100 supports many websites wherein each of the one or more user devices 110, 112, 114, and 116 may be in operative communication with each other and with the websites 120 via the network 102. Similarly for purposes of illustration, the embodiment of system 100 shown by FIG. 1 includes four (4) user devices 110, 112, 114, and 116. However, it is to be appreciated that in practice system 100 may include many more user devices are supported. The social networking systems 130 may be operated by various social network providers. The websites 120 and the social networking systems 130 may be operated by different entities. In various embodiments, the social networking systems 130 and the websites 120 may operate in conjunction to provide social networking and workflow management services to users of the social networking systems 130 and websites 120. In this sense, the social networking systems 130 may provide a platform, or backbone, which other systems like the websites 120 may use to provide social networking services and functionalities to users across the Internet and, similarly, the websites 120 may provide a platform, or backbone, which other systems like the social networking systems 130 may use to provide workflow management services and functionalities to users across the Internet. It is to be appreciated that while a set of websites 120 and a set of social networking systems 130 are illustrated, a wide range of different entities may provide different subsystems in operative communication via the network 102 as may be necessary and/or desired.

The user devices 110, 112, 114, and 116 comprise one or more computing devices that can receive input from a user and can transmit and receive data via network 102. For example, the user devices 110 and 116 may be smart phones as shown, the user device 112 may be a laptop computer as shown, or a desktop computer, and the user device 114 may be a personal digital assistant (PDA) such as a tablet device or the like. It is to be appreciated that the user devices 110, 112, 114, and 116 may comprise any type of device including computing functionality and data communication capabilities. The user devices 110, 112, 114, and 116 are configured to communicate with the websites 120 and the social networking systems 130 via the network 102, which may comprise any combination of local area and/or wide area networks, using both wired and wireless communication systems.

In one example embodiment, the user devices 110, 112, 114, and 116 display content from the websites 120, from the social networking systems 130, and/or from one or more application programs such as browser application programs or the like that are executed locally relative to the user devices 110, 112, 114, and 116 by processing markup language documents and/or formatted data received from the websites 120 or from the social networking systems 130 using browser applications or the like. The markup language documents identify content and one or more instructions describing formatting or presentation of the content. By executing the instructions included in the markup language documents and/or formatted data, the browser applications executing in the user devices 110, 112, 114, and 116 display the identified content using the format or presentation described by the markup language documents and/or formatted data. For example, the markup language documents may include instructions for generating and displaying a web page having multiple frames that include text and/or image data retrieved from the websites 120 and/or the social networking systems 130. In various embodiments, the markup language documents may comprise data files including extensible markup language (XML) data, extensible hypertext markup language (XHTML) data or other markup language data. In the various implementations herein, the formatted data may be in the form of JSON, XML, or any other format as may be necessary and/or desired.

Network 102 may comprise one or more servers including for example an email server 104 operable to host one or more email mailboxes, and to send and receive email messages over network 102, and a telephony server 106 operable to facilitate communication between the user devices 110, 112, 114, and 116 including for example video calling, call control, speech to text (STT), text to speech (TTS), audio and video conferencing, text messaging, instant messaging, faxing, and the like. Email server 104 may comprise suitable interface circuitry for effecting email communication between the user devices 110, 112, 114, and 116 via network 102. Example email servers include hosted services such as GMail and Sendgrid, or installed servers such as redbox or postfix, among others, or custom developed libraries supporting SMTP, IMAP and other protocols. Telephony server 106 may use Internet Protocol (IP) as a data communication protocol or any other digital protocol to transfer communications over the network 102. The telephony server may be a hosted service such as Twilio or Plivo among others, or hosted such as FreeSwitch or Asterisk among others, or custom developed libraries integrating via SIP, H.323 or other protocols.

It is to be appreciated that although the systems and methods for facilitating collaboration on a map and also the systems and methods for facilitating workflow management on a map of the various implementations herein are described as executing in the one or more depicted user devices 110, 112, 114, and 116, in various embodiments, the systems and methods may be incorporated into other devices and/or systems such as in one or more servers 104, 106 and/or in one or more other websites 120 or social networking systems 130 (e.g., as a distributed system), and/or as a stand-alone system.

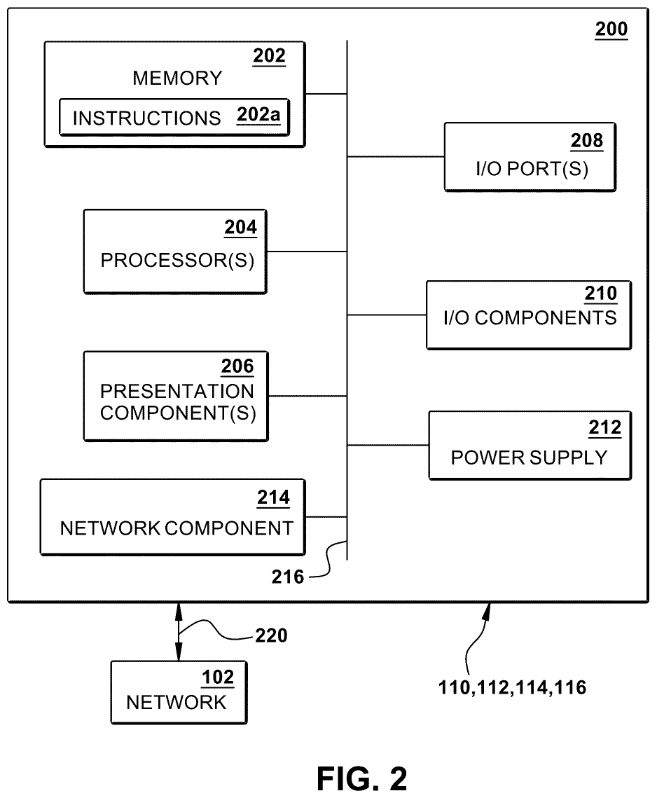

FIG. 2 is a block diagram of an example computing device 200 suitable for implementing an electronic user device such as for example any of the one or more user devices 110, 112, 114, and 116, and/or any of the server or other devices 104, 106, 120, 130 in accordance with various example embodiments. The block diagram of the computing device 200 illustrated in FIG. 2 illustrates a device suitable further for implementing various functional and other aspects of the disclosed systems and methods including operations and functions related to any of the one or more user devices 110, 112, 114, and 116, and/or any of the server or other devices 104, 106, 120, 130 in accordance with various example embodiments. FIG. 2 and the following discussion provide a brief, general description of a computing device 200 in and/or on which one or more or the implementations of one or more of the methods and/or system set forth herein may be implemented. The computing device 200 of FIG. 2 is merely an example of a suitable computing environment and is not intended to suggest any limitation as to the scope of use or functionality of the computing environment. Example computing devices include, but are not limited to, personal computers, servers comprising computers, cloud platforms, hand-held or laptop devices, mobile devices (such as mobile phones, mobile consoles, tablets, media players, and the like), multiprocessor systems, consumer electronics, minicomputers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 200 includes a non-transient memory device 202, one or more processor devices 204, and one or more presentation components 206. These components can be modularly combined or distributed, depending on the specific implementation and application. The disclosed examples associated with the computing device 200 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 2 and the references herein to a “computing device.” The disclosed examples are also practiced in distributed computing environments, where tasks are performed by remote-processing devices that are linked through a communications network. Further, while the computing device 200 is depicted as a single device, in one example, multiple computing devices work together and share the depicted device resources. For instance, in one example, the memory 202 is distributed across multiple devices, the processor(s) 204 provided are housed on different devices, and so on.

In one example, memory 202 includes any of the computer-readable media discussed herein. In one example, memory 202 is used to store and access instructions 202a configured to carry out the various operations disclosed herein. In some examples the memory 202 is used to store and access instructions 202a configured to provide systems and methods for facilitating collaboration on a map and/or workflow management on a map, in accordance with the example implementations described herein. In some examples, memory 202 includes computer storage media in the form of volatile and/or nonvolatile memory, removable or non-removable memory, data disks in virtual environments, or a combination thereof. In one example, the processor(s) 204 includes any quantity of processing units that read data from various entities, such as the memory 202 or input/output (I/O) components 210. Specifically, processor(s) 204 are programmed to execute computer-executable instructions for implementing aspects of the disclosure. In one example, the instructions 202a are performed by processor 204, by multiple processors within the computing device 200, or by a processor external to the computing device 200. In some examples, the processor(s) 204 are programmed to execute instructions such as those illustrated in the flow charts discussed herein and depicted in the accompanying drawings.

In other implementations, the computing device 200 may include additional features and/or functionalities. For example, the computing device 200 may also include additional storage (e.g., removable and/or non-removable) including, but not limited to, magnetic storage, optical storage, and the like. Such additional storage is illustrated in FIG. 2 by memory 202. In one implementation, computer readable instructions to execute or otherwise perform one or more implementations provided herein may be in memory 202 as described herein. Memory 202 may also store other computer readable instructions to implement an operating system, an application program and the like. Computer readable instructions may be loaded in memory 202 for execution by the processor(s) 204, for example.

The presentation component(s) 206 present data indications to an operator or to another device. In one example, the presentation components 206 include a display device, speaker, printing component, vibrating component, etc. One skilled in the art will understand and appreciate that computer data is presented in a number of ways, such as visually in a graphical user interface (GUI), audibly through speakers, wirelessly between the computing device 200, across a wired connection, or in other ways. In one example, the presentation component(s) 206 are not used when processes and operations are sufficiently automated that a need for human interaction is lessened or not needed. I/O ports 208 allow the computing device 200 to be logically coupled to other devices including the I/O components 210, some of which are built in. Implementations of the I/O components 210 include, for example but without limitation, a microphone, keyboard, mouse, joystick, pen, game pad, satellite dish, scanner, printer, wireless device, camera, etc.

The computing device 200 includes a bus 216 that directly or indirectly couples the following devices: the memory 202, the one or more processors 204, the one or more presentation components 206, the input/output (I/O) ports 208, the I/O components 210, a power supply 212, and a network component 214. Computing device 200 should not be interpreted as having any dependency or requirement related to any single component or combination of components illustrated therein. Bus 216 represents one or more busses (such as an address bus, data bus, or a combination thereof). Although the various blocks of FIG. 2 are shown with lines for the sake of clarity, some implementations blur functionality over various different components described herein.

The components of the computing device 200 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of computing device 200 may be interconnected by a network. For example, memory 202 may be comprised of multiple physical memory units located in different physical locations interconnected by a network.

In some examples, the computing device 200 is communicatively coupled to the network 102 using the network component 214. In some examples, the network component 214 includes a network interface card and/or computer-executable instructions (e.g., a driver) for operating the network interface card. In one example, communication between the computing device 200 and other devices occurs using any protocol or mechanism over a wired or wireless connection 220. In some examples, the network component 214 is operable to communicate data over public, private, or hybrid (public and private) connections using a transfer protocol (REST, HTTP, websockets, RTP, TCP, UDP and the like), between devices wirelessly using short range communication technologies (e.g., near-field communication (NFC), Bluetooth® branded communications, or the like), or a combination thereof.

The connection 220 may include, but is not limited to, a modem, a Network Interface Card (NIC), an integrated network interface, a radio frequency transmitter/receiver, an infrared port, a USB connection or other interfaces for connecting the computing device 200 to other computing devices. The connection 220 may transmit and/or receive communication media.

Although described in connection with the computing device 200, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the Figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

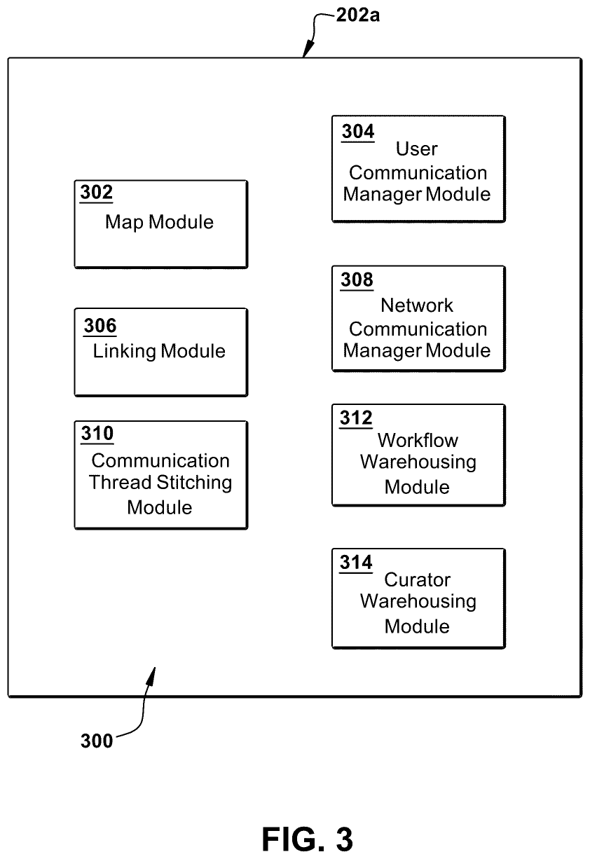

As noted above, in one example, the computer-executable instructions 202a are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. In this connection and with reference now to FIG. 3, a block diagram representation of computer-executable instructions is illustrated organized into one or more computer-executable components or modules in accordance with an example embodiment. In accordance with an example embodiment, system 100 (FIG. 1) is provided for facilitating collaboration and workflow management on a map. The facilitated collaboration and workflow management may include management of communication between users of the system, management of relationships between the users, management of schedules between users of the system, and the like. The system 100 as illustrated includes one or more computer processors 204 (FIG. 2) and one or more non-transient memory devices 202 operatively coupled with the one or more computer processors. The one or more non-transient memory devices store computer executable instructions 202a that when executed by the one or more computer processor devices cause the system to facilitate the collaboration management.

In accordance with a further example embodiment, system 100 (FIG. 1) is provided for facilitating workflow management on a map. The facilitated workflow management may include management of communication between users of the system, management of tasks between and/or amongst the users, and the like. The system 100 as illustrated includes one or more computer processors 204 (FIG. 2) and one or more non-transient memory devices 202 operatively coupled with the one or more computer processors. The one or more non-transient memory devices store computer executable instructions 202a that when executed by the one or more computer processor devices cause the system to facilitate the workflow management.

In an implementation the computer executable instructions 202a may be stored in and/or otherwise be organized in a set 300 of one or more logical “modules.” The computer executable instructions 202a will be described herein in terms of “modules” for ease of discussion. It is to be appreciated, however, that the modules comprising the computer executable instructions 202a can be executed separately and/or concurrently on or by the system in accordance with the example implementations.

In an implementation, a map module 302 is provided. The map module 302 is executable by a server or serverless platform or one or more computer processor devices 204 to cause the system to display maps on screens of electronic devices 110, 112, 114 in a manner to be described in greater detail below.

In an implementation, a user communication manager module 304 is provided. The user communication manager module 304 is executable by a server or serverless platform or one or more computer processor devices 204 to cause the system to receive messages from users of the system in a manner to be described in greater detail below.

In an implementation, a linking module 306 is provided. Linking module 306 is executable by a server or serverless platform or one or more computer processor devices 204 to cause the system to link user messages with the selected bounded areas on the displayed maps in a manner to be described in greater detail below.

In an implementation, a network communication manager module 308 is provided. The network communication manager module 308 is executable by a server or serverless platform or one or more computer processor devices 204 to cause the system to transmit and receive messages with the network 102 in a manner to be described in greater detail below.

In an implementation, a communication thread stitching module 310 is provided. The communication thread stitching module 310 is executable by a server or serverless platform or the one or more computer processor devices 204 to cause the system to associate messages with selected bounded areas on the displayed maps in a manner to be described in greater detail below.

In accordance with a further example embodiment, system 100 (FIG. 1) is provided for facilitating workflow management on a map. The facilitated workflow management may include management of communication between users of the system, management of tasks between and/or amongst the users, and the like. The system 100 as illustrated includes one or more computer processors 204 (FIG. 2) and one or more non-transient memory devices 202 operatively coupled with the one or more computer processors. The one or more non-transient memory devices store computer executable instructions 202a that when executed by the one or more computer processor devices cause the system to facilitate the workflow management.

In an implementation, a workflow warehousing module 312 is provided. The workflow warehousing module 312 is executable by a server or serverless platform or the one or more computer processor devices 204 to cause the system to identify a stored task item associated with a user based on the map module 302 receiving a selection of a workflow management initiation button or other indicia from a user in a manner to be described in greater detail below.

In an implementation, a curator warehousing module 314 is provided. The curator warehousing module 314 is executable by a server or serverless platform or the one or more computer processor devices 204 to cause the system to curate identified stored messaging task items to a user from a plurality of historical message dialogs relative to a plurality of locations on a map based on one or more criteria in a manner to be described in greater detail below.

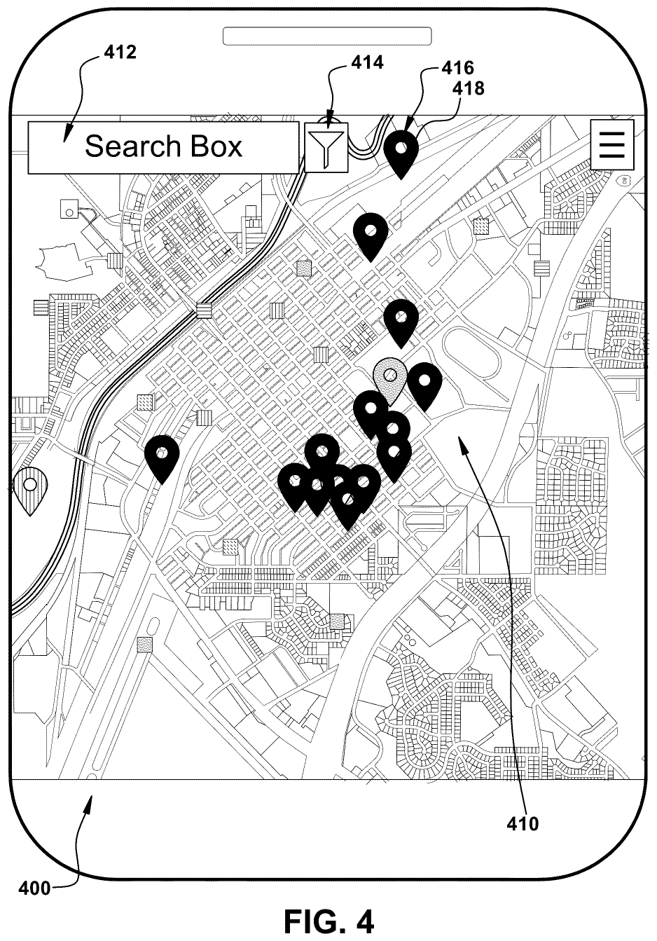

FIG. 4 illustrates an example of a user interface 400 displaying a map 410, a search dialog box 412, and a filter selection dialog box 414 in accordance with an example embodiment. As shown, the map 410 is displayed on the screen or as a projection of one or more of the electronic devices 110, 112, 114, 116.

In an implementation, a query submitted in the search dialog box 412 by the user of the electronic device for searching the map 410 displayed may be filtered by selection in the filter selection dialog box 414 selection of one or more filter criteria or industry algorithms stored for example in the memory device 202 including for example: filter query by Name(s), Icon, Acreage, Comments, Zoning, Traffic Counts, Tags, Users, Tenants, and/or industry best practice rules and/or procedures. The system in accordance with the implementation is operable to present to the user search results on the map 410 displayed on the screen or as a projection of one or more of the electronic devices 110, 112, 114, 116 in accordance with the filter queries relating to any of the selected one or more Name, Icon, Acreage, Comments, Zoning, Traffic Counts, Tags, Users, Tenants, etc. filter aspects or rules.

In accordance with an embodiment, public data as well as private data may be accumulated relative to locations on the map, and indexed to the locations on the map for selectable periods of time. In accordance with an example implementation, the selectable map locations may be predetermined parcels in the map arranged or otherwise displayed on the map for selection by a user of the system. Data such as personal data, private data, public data, notes, comments, messages, and the like may be presented by a user relative to selected map locations or parcels, for privately or publicly publishing the notes, comments, messages, and the like on the map and in association or otherwise linked with the selected map locations or parcels for recall later. The information may be linked to a map location or parcel and represented in accordance with an implementation by indicia 416 such as for example virtual pin indicia 418. In this way, the system in accordance with an implantation may provide users who select the pin indicia 418 information linked to the map location or parcel that is associated with the pin indicia 418 selected by the user. In some implementations subsets of the information linked to the map locations is provided to users based on qualifications of the users such as being members of a group, being a public user, being a user having a private relationship with user who posted the information for linking to the map location or parcel, or the like as will be explained in greater detail below.

It is to be appreciated that the map 410 displayed on the user interface 400 of the user in control of the device may be particular to the user and, in this regard, provide collaboration on a map and/or workflow management information on the map that is relative to the user. Such information may include a particular set of indicia 416 such as a particular set of virtual pin indicia relative to the user. In this sense, other users may be presented with their own collaboration and workflow management information on the map that is relative to those users.

In accordance with an implementation, social media profile information of various users may be published on the map for access by other users having authorization and/or other qualifications to view or otherwise access the published social media profile information. By way of example a real estate developer/broker may post his or her profile and other information to the system at various locations on the map whereby other users of the system having the proper qualifications or the like and viewing the map 410 may view or otherwise access the published social media profile information of the real estate developer/broker on the map. In an implementation the social media profile information of various users may be published on the map at locations on the map whereby the other users having authorization and/or other qualifications to view or otherwise access the published social media profile information may do so by selecting the one or more virtual pin indicia 418.

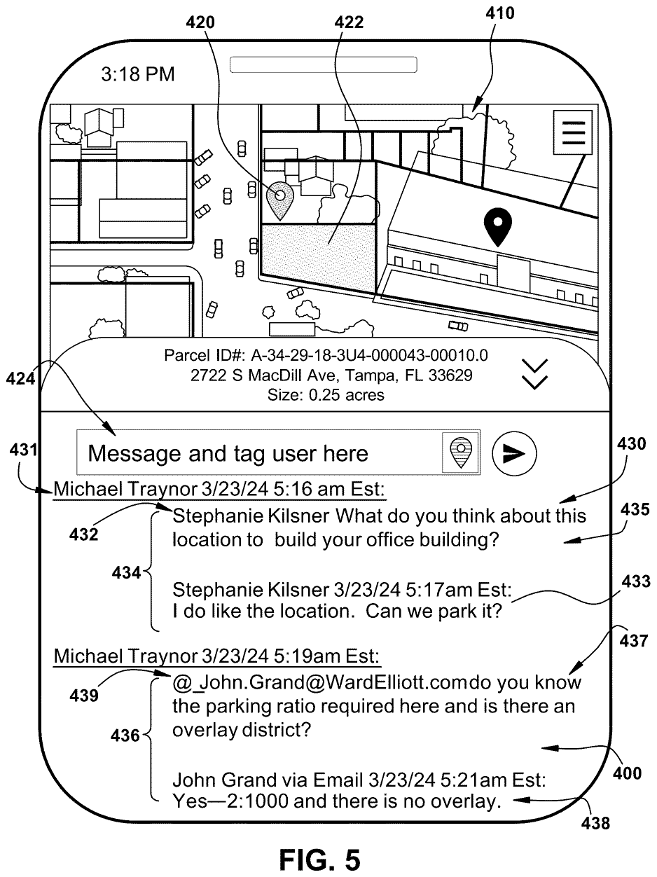

FIG. 5 is an example of a user interface 400 illustrating facilitating collaboration on a map in accordance with an example embodiment. As described above, the map module 302 (FIG. 3) is executable by the one or more computer processor devices 204 (FIG. 2) to cause the system to display a map 410 on a screen of an electronic device, receive a selection of a first location 420 of the map 410 from a user of the electronic device and highlight 422 the selected first location 420 relative to the map displayed on the screen of the electronic device. As shown, the highlighted 422 selected first location 420 on the map displayed on the screen of the electronic device is a closed bounded area. In accordance with an implementation, the closed bounded areas may be selectable parcels such as provided or otherwise determined by local authorities or governmental entities including, for example local auditors such as for example county auditors. It is to be appreciated that the selectable locations on the map in the several implementations of the methods and systems described herein may be closed bounded areas drawn or otherwise determined by users of the systems and methods and, in this sense, may be specialized and/or proprietary to the user and to other users having authorization and/or other qualifications to view or otherwise access the specialized and/or proprietary closed bounded areas drawn or otherwise determined by a user.

With continued reference to FIG. 5 the user communication manager module 304 (FIG. 3) is executable by the one or more computer processor devices 204 (FIG. 2) to cause the system to receive a first tendered message 430 from a first user 431 in association with the selected first location 420 being displayed and/or otherwise highlighted 422 on the screen, wherein the first tendered message 430 identifies a targeted recipient 432. The first tendered message 430 may be received from the first user 431 in association with the selected first location 420 using a dialog box 424 or the like.

In accordance with implementations herein, the first tendered message 430 may identify the targeted recipient 432 in various ways such as for example by using a username of the targeted recipient 432, an email contact of the targeted recipient 432, a cellular phone contact of the targeted recipient 432, or the like. In this way the first tendered message 430 may be routed to the targeted recipient 432 using the email server 104 (FIG. 1) for the targeted recipient 432 being identified by the first user 431 in the dialog box 424 using an email contact of the targeted recipient 432, or the first tendered message 430 may be routed to the targeted recipient 432 using the telephony server 106 (FIG. 1) for the targeted recipient 432 being identified by the first user 431 in the dialog box 424 using a cellular phone contact of the targeted recipient 432.

In accordance with the implementation illustrated, the linking module 306 (FIG. 3) is executable by the one or more computer processor devices 204 (FIG. 2) to cause the system to link the first tendered message 430 with the selected first location 420.

Further in accordance with the implementation illustrated, the network communication manager module 308 (FIG. 3) is executable by the one or more computer processor devices 204 (FIG. 2) to cause the system to transmit the first tendered message 430 received from the first user 431 to one or more server devices 104, 106 (FIG. 1) of the associated communication network 102 in operative communication with the system, and receive via the one or more server devices of the associated network a first reply message 433 from the targeted recipient 432 in reply to the first tendered message 430. It is to be appreciated that in accordance with an implementation the network communication manager module 308 (FIG. 3) is executable by the one or more computer processor devices 204 (FIG. 2) to cause the system to transmit the first tendered message 430 received from the first user 431 directly to the targeted recipient 432 via a direct application route 107 (FIG. 1) for targeted recipients having devices that are actively executing the subject systems and methods in an application local to the intended recipients' device(s).

Yet still further in accordance with the implementation illustrated, the communication thread stitching module 310 (FIG. 3) is executable by the one or more computer processor devices 204 (FIG. 2) to cause the system to associate the first reply message 433 received from the targeted recipient 432 with the first tendered message 430 and, based on associating the first reply message 433 with the first tendered message 430, stitch the first reply message 433 with the first tendered message 430 linked with the selected first location 420 as a first dialog thread 434 linked with the selected first location 420.

With continued reference to FIG. 5 and still further in accordance with the implementation illustrated, map module 302 (FIG. 3) is executable by the one or more computer processor devices 204 (FIG. 2) to cause the system to display 435 the first dialog thread 434 comprising the first reply message 433 stitched with the first tendered message 430 on the screen of the electronic device in association with the selected first location 420 being displayed 422 on the screen 206 of the electronic device 110, 112, 114, 116.

It is to be appreciated that in accordance with an implementation and as will be described in greater detail below, the system and method is operable to private and public collaboration group memberships. In this regard and as shown in FIG. 5, the first dialog thread 434 comprising the first tendered message 430 stitched with the first reply message 433 and linked with the first location 420 is a collaboration between the first user 431 and the targeted recipient 432, whereas a second dialog thread 436 comprising a tendered message 437 stitched with a reply message 438 and linked with the first location 420 is a collaboration between the first user 431 and a further targeted recipient 439 different than the targeted recipient 432.

In the example, the first user 431 is in a first collaboration group membership with the first targeted recipient 432, and in a second collaboration group with the second targeted recipient 439. In this way, the system presents to the first user 431 both dialog threads 434, 436 because the first user 431 is in both collaboration group memberships.

It is further to be appreciated that in the example the system is configured to generate a different display (not shown) showing only the first dialog thread 434 to the first targeted recipient 432 when the first targeted recipient 432 selects the first location 420 displayed on the map 410 on his/her device. Similarly in the example the system is configured to generate a further different display (not shown) showing only the second dialog thread 436 to the second targeted recipient 439 when the second targeted recipient 439 selects the first location 420 displayed on the map 410 on his/her device.

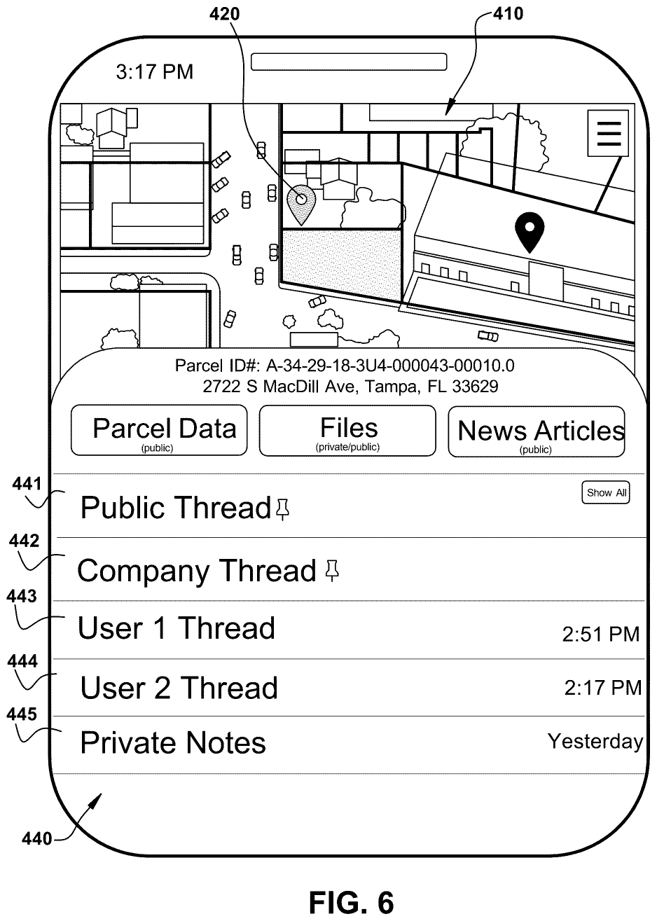

FIG. 6 illustrates an example of a user interface displaying collaboration facilitation on a map between multiple users in accordance with an example embodiment. In this regard and in accordance with a further implementation, other communication threads (not shown) stitched together and linked to the location 420 may be presented to the first user 431. The other communication threads stitched together and linked to the location 420 may be by and between users other than the first user 431. In this regard, the communication thread stitching module 310 (FIG. 3) is executable by the one or more computer processor devices 204 (FIG. 2) to cause the system to determine one or more other dialog threads linked with the selected first location 420, wherein the one or more other dialog threads comprise one or more communications related to the selected first location 420 between one or more other users of the system different than the first user 431 of the system. Further in connection with this implementation, the map module 302 (FIG. 3) is executable by the one or more computer processor devices 204 (FIG. 2) to cause the system to display on the screen of the one or more user devices 110, 112, 114, and 116 the one or more other dialog threads in association with the selected first location being displayed on the screen of the electronic device following selection by the user from a selection panel 440 of one or more dialog threads 441-444, and a personal notes selection dialog box 445. In the examine implementation the user may select a public thread tab 441 to view public information and/or discussions that relate to the selected first location 420 for facilitating collaboration on the map 410.

Similarly, the user may select a company thread tab 442 to view information and/or discussions that relate to the selected first location 420 for facilitating collaboration on the map 410 between users who are credentialed by the company to view the view information and/or discussions that relate to the selected first location 420. By way of example the company thread tab 442 permits access to the information and/or discussions that relate to the selected first location 420 only to those who are employees of the company.

It is to be appreciated that users may also post messages and information to recipients using the company thread tab 442. The user may select a company thread tab 442 to view information and/or discussions that relate to the selected first location 420 and then, having been transferred to the company thread, also post messages and information to the other users associated with the company thread.

Some companies and/or other user groups may be public and, therefore, stitched messages and information exchanged in these threads linked to the locations on the map are visible to all users whether they are associated with such companies and/or user groups. In this regard, the systems and methods herein support public group broadcasts to plural recipients. The user communication manager module 304 (FIG. 3) is executable by the one or more computer processor devices 204 (FIG. 2) to cause the system to receive the first tendered message from the user in association with the selected first location being displayed on the screen, wherein the first tendered message comprises a user group name that identifies a plurality of targeted recipients that are associated as members of a first user group having the name.

The network communication manager module 308 (FIG. 3) is executable by the one or more computer processor devices 204 (FIG. 2) to cause the system to transmit the first tendered message comprising the user group name received from the user to one or more server devices of an associated network in operative communication with the system, and receive via the one or more server devices of the associated network a plurality of first reply messages from the plurality of targeted recipient members of the first group having the name in reply to the first tendered message.

The communication thread stitching module 310 (FIG. 3) is executable by the one or more computer processor devices 204 (FIG. 2) to cause the system to associate the plurality of first reply messages received from the plurality of targeted recipients with the first tendered message and based on associating each of the plurality of first reply messages with the first tendered message, stitch each of the plurality of first reply messages with the first tendered message linked with the selected first location as a first group dialog thread linked with the selected first location.

As described above, some companies and/or other user groups may be public and, therefore, stitched messages and information exchanged in these threads linked to the locations on the map are visible to all users whether they are associated with such companies or user groups. However, some companies and/or other user groups may be private and, therefore, stitched messages and information exchanged in these threads linked to the locations on the map are visible only to users who are associated with such companies and/or user groups. In this regard, the systems and methods herein support private group broadcasts to plural recipients.

The user communication manager module 308 (FIG. 3) is executable by the one or more computer processor devices 204 (FIG. 2) to cause the system to receive the first tendered message from the user in association with the selected first location being displayed on the screen, wherein the first tendered message comprises a private user group name that identifies a plurality of targeted private group recipients that are associated as members of a first private user group having the private user group name.

The network communication manager module 308 (FIG. 3) is executable by the one or more computer processor devices 204 (FIG. 2) to cause the system to receive via the one or more server devices of the associated network a plurality of first reply messages from the targeted private group of recipients in reply to the first tendered message.

The communication thread stitching module 310 (FIG. 3) is executable by the one or more computer processor devices 204 (FIG. 2) to cause the system to associate the plurality of first reply messages received from the targeted group of recipients with the first tendered message, and based on associating each of the plurality of first reply messages with the first tendered message, stitch each of the plurality of first reply messages with the first tendered message linked with the selected first location as a first private group dialog thread linked with the selected first location.

The map module 302 (FIG. 3) is executable by the one or more computer processor devices 204 (FIG. 2) to cause the system to prevent displaying on the screen of the electronic device the first private group dialog thread to users of the system other than users identified by the private user group name as being members of the targeted private group of recipients.

Further similarly and with continued reference to FIG. 6, the user may select a user 1 thread tab 443 or a user 2 thread tab 444 to view information and/or discussions that include the user 1 and user 2, respectively, and that relate to the selected first location 420 for facilitating collaboration on the map 410 between the user of the device and the other users, i.e., the user 1 and user 2.

In addition, a private notes tab 445 enables access to the user to his or her private notes related to the selected first location 420 for facilitating collaboration on the map 410 between the user of the device and other users who may be credentialed by the user of the device to view the view information and/or discussions in the user's private notes and that relate to the selected first location 420.

In the implementation illustrated, the map module 302 (FIG. 3) is executable by the one or more computer processor devices 204 (FIG. 2) to cause the system to display on the screen of the electronic device the one or more other dialog threads and/or private notes in association with the selected first location 420 being displayed on the screen of the electronic device.

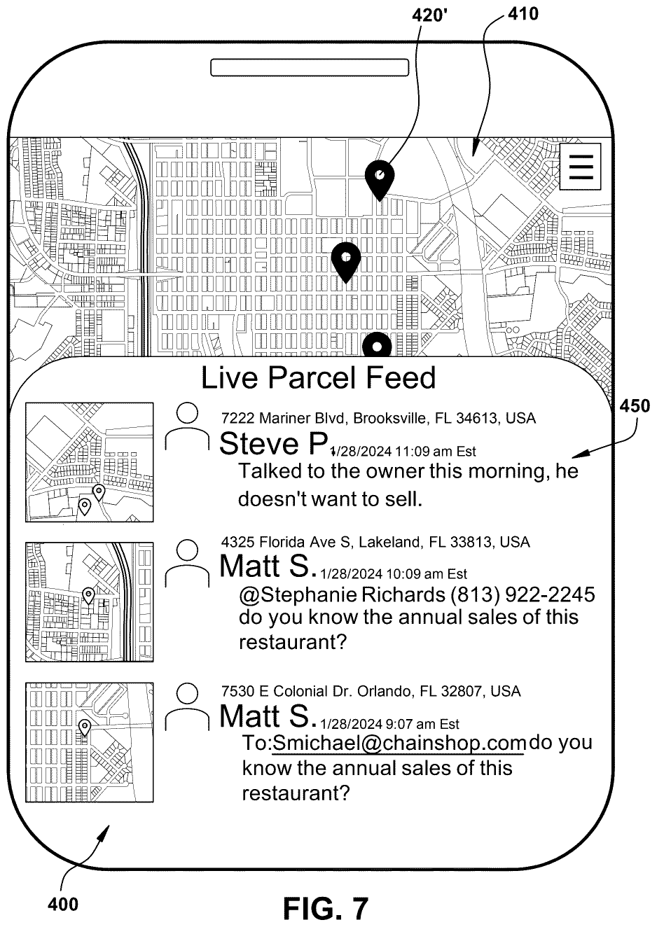

FIG. 7 illustrates an example of a user interface 400 displaying collaboration facilitation on a map relative to a selected second location and including live information feeds between multiple users in accordance with an example embodiment.

In accordance with an implementation, the map module is 302 (FIG. 3) is executable by the one or more computer processor devices 204 (FIG. 2) to cause the system to receive a selection of a second location 420′ of the map from the user of the electronic device, and display the selected second location on the screen of the electronic device. The communication thread stitching module 304 (FIG. 3) is executable by the one or more computer processor devices 204 (FIG. 2) to cause the system to determine one or more other dialog threads linked with the selected second location, wherein the one or more other dialog threads comprise one or more communications related to the selected second location 420′ between one or more other users of the system different than the user of the system. The map module 302 is executable by the one or more computer processor devices to cause the system to display on the screen of the electronic device the one or more other dialog threads 450 in association with the selected second location being displayed on the screen of the electronic device.

In addition to the above in one or more implementations, the one or more other dialog threads 450 in association with the selected second location being displayed on the screen of the electronic device comprise live user dialog feeds. In an implementation the live user dialog feeds are live parcel feeds that include messages and other information exchanged between users relative to the second location 420′. The live feed messages and other information exchanged between the users are stitched together and linked to the second location 420′.

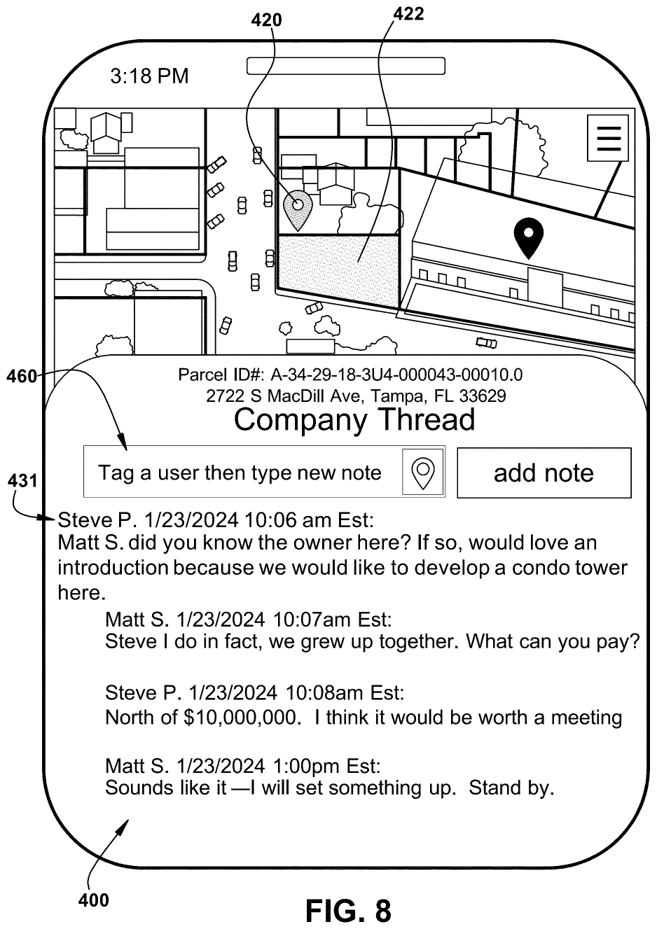

It is to be appreciated that the systems and methods described herein are operable to support plural tagging modalities. In this regard, FIG. 8 illustrates an example of a user interface displaying collaboration facilitation on a map including support of plural tagging modalities. In the example implementation the user communication manager module is executable by the one or more computer processor devices to cause the system to receive a first tendered message from a first user 431 in association with the selected first location being displayed on the screen as a first tendered message comprising a tag 460 that identifies the targeted recipient. In the various implementations, the tag may comprise one or more of a system username that identifies the targeted recipient, an email contact address that identifies the targeted recipient, a cellular phone contact number that identifies the targeted recipient, and/or a social media contact character set that identifies the targeted recipient.

In an implantation the network communication manager module 308 is executable by the one or more computer processor devices to cause the system to select an associated network in operative communication with the system based on the tag comprising the one or more of the system username, the email contact address, the cellular phone contact number, and/or the a social media contact character set, and transmit the first tendered message to one or more server devices 104, 106 (FIG. 1) of the selected associated network or directly via a direct application route 107 (FIG. 1) for targeted recipients having devices that are actively executing the subject systems and methods in an application local to the intended recipients' device(s).

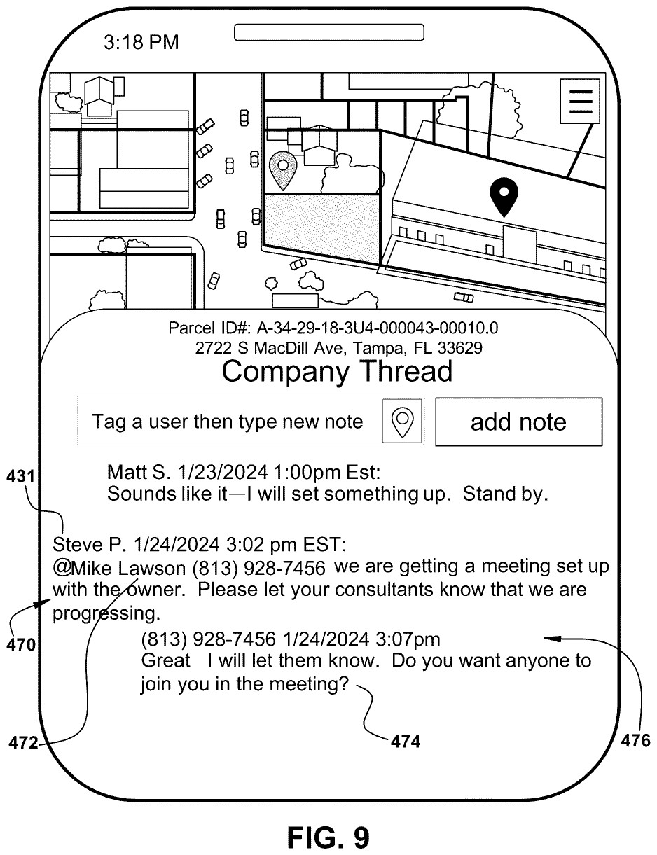

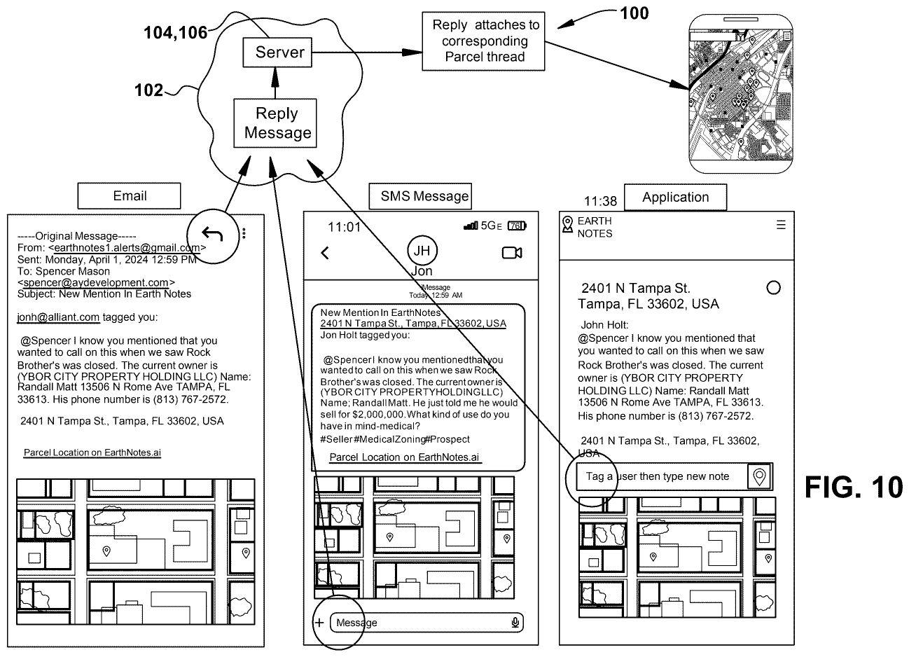

FIGS. 9 and 10 illustrate an example of a user interface and network system displaying collaboration facilitation on a map including support of linking plural tagging modalities to locations on a map. A user's message 470 is sent to a user using a mechanism other than the direct application route 107 (FIG. 1) for targeted recipients having devices that are actively executing the subject systems and methods in an application local to the intended recipients' device(s). The user's message 470 may be sent to a targeted recipient 472 using the targeted recipient's 472 email address via the email server 104, for example. Similarly, the user's message 470 may be sent to the targeted recipient 472 by SMS texting using the targeted recipient's 472 mobile phone number via the telephony server 106, for example. Further, the user's message 470 may be sent to the targeted recipient 472 using any other apparatus or systems other than the direct application route 107 (FIG. 1) for targeted recipients having devices that are actively executing the subject systems and methods in an application local to the intended recipients' device(s).

In any case, the systems and methods of the implementations described herein are operable to stitch the reply message 474 from the targeted recipient 472 with the user's message 470 as a message thread 476, wherein the message thread 476 is linked to the selected first location 420 on the map and displayed on the screen of the electronic device such as being highlighted 422 on the map displayed on the screen of the electronic device for example. As shown in FIG. 10 the reply message 474 from the targeted recipient 472 may be routed by one or more of the servers 104, 106 when the reply message 474 from the targeted recipient 472 is sent to the requester user 431 using any other apparatus or systems other than the direct application route 107 (FIG. 1) for targeted recipients having devices that are actively executing the subject systems and methods in an application local to the intended recipients' device(s). As further shown in FIG. 10 the reply message 474 from the targeted recipient 472 may be routed directly to the requester user 431 using the direct application route 107 (FIG. 1) for targeted recipients having devices that are actively executing the subject systems and methods in an application local to the intended recipients' device(s).

In either case and in accordance with the example implementations herein the reply message 474 from the targeted recipient 472 is stitched together with the user's message 470 as a message thread 476, wherein the message thread 476 is linked to the selected first location 420 on the map and displayed on the screen of the electronic device such as being highlighted 422 on the map displayed on the screen of the electronic device for example.

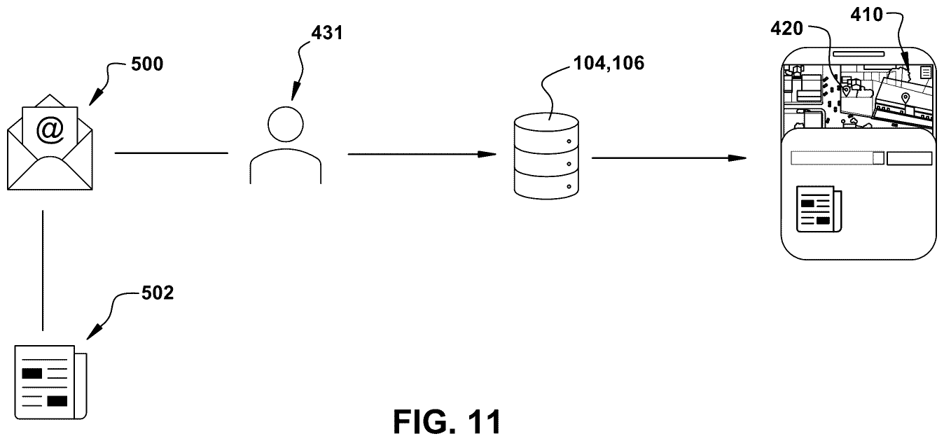

FIG. 11 is a schematic view showing an example of information collaboration on a map in accordance with an example embodiment. As shown there, the first user 431 may receive information 502 via email 500. The information may be news articles, publications, sales brochures, public or private announcements, or the like. It is to be appreciated that the first user 431 may receive the information 502 by other means including for example creating the information independently.

In the example implementation the user 431 may forward the information 502 to the one or more servers 104, 106 (FIG. 1) whereat the system 100 may parse the information, and stitch the information with other related information that may be available and if necessary or desired, and then link the stitched information set to a selected location on the map such as for example to the first location 420 of the map 410. The stitched information may be automatically linked to users' map(s).

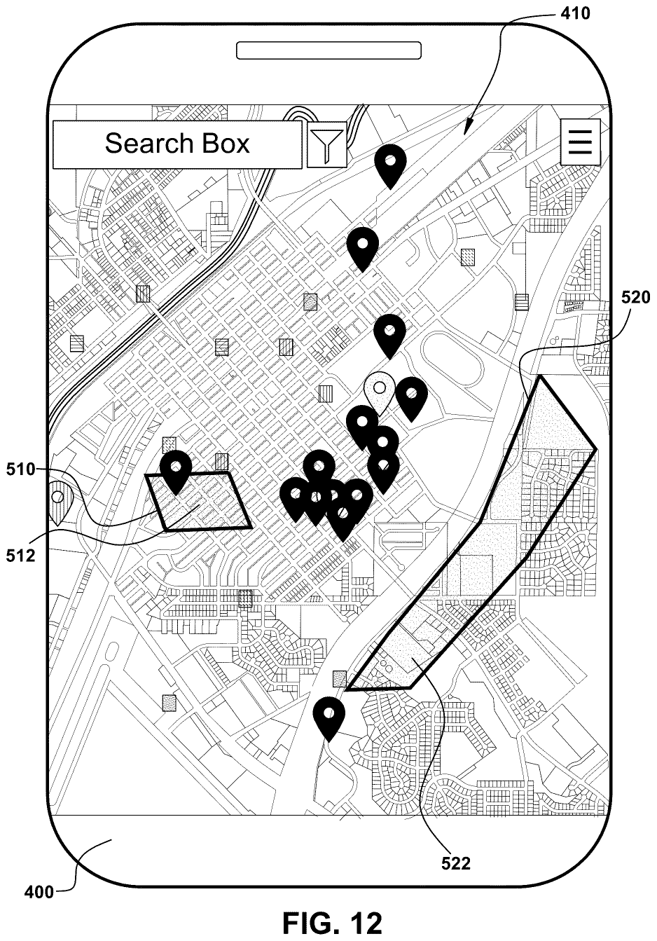

FIG. 12 is a schematic view showing a further example of information collaboration using location layers on a map in accordance with an example embodiment. In accordance with the implementation. With reference now to that Figure, the map module 302 is executable by the one or more computer processor devices to cause the system to display a map 410 on a screen of an electronic device, receive a selection of a first area 510 of the map from a user of the electronic device, and display and/or otherwise highlight 512 the selected first area 510 relative to the map displayed on the screen of the electronic device. In the example, the selected first area 510 may comprise several locations on the map that were previously established such as for example in a county auditor office wherein the previously established locations may comprise land parcel locations or the like. As shown in the example, the selected first area 510 spans several of the several locations on the map that were previously established.

Similarly, the map module 302 is executable by the one or more computer processor devices to receive a selection of a second area 520 of the map from a further user of the electronic device, and display and/or otherwise highlight 522 the selected second area 520 relative to the map displayed on the screen of the electronic device. In the example, the selected second area 520 may similarly comprise several locations on the map that were previously established such as for example in a county auditor office wherein the previously established locations may comprise land parcel locations or the like. As shown in the example, the selected second area 520 spans several of the several locations on the map that were previously established.

The user communication manager module is executable by the one or more computer processor devices to cause the system to receive a first tendered message from a user in association with either of the selected first or second areas 510, 520 being displayed on the screen, wherein the first tendered message identifies a targeted recipient.

The linking module is executable by the one or more computer processor devices to cause the system to link the first tendered message with the selected first or second areas. In further addition and when the first tendered message received from the user is in association with the selected first area 510, the system 100 is operable to stitch the first tendered message received from the user together with any other messages received in association with the selected first area 510, and to link the stitched one or more messages with all of the several locations on the map that are spanned by the selected first area 510 and that were previously established such as for example in a county auditor office wherein the previously established locations may comprise land parcel locations or the like. In that way, users of the system may collaborate on the map with other users in a collaboration plane of the selected first area 510 and/or in a collaboration plane of the several locations on the map that are spanned by the selected first area 510 and that were previously established beforehand.

In still further addition and when the second tendered message received from the user is in association with the selected second area 520, the system 100 is operable to stitch the second tendered message received from the user together with any other messages received in association with the selected second area 520, and to link the stitched one or more messages with all of the several locations on the map that are spanned by the selected second area 520 and that were previously established such as for example in a county auditor office wherein the previously established locations may comprise land parcel locations or the like. In that way, users of the system may collaborate on the map with other users in a collaboration plane of the selected second area 520 and/or in a collaboration plane of the several locations on the map that are spanned by the selected second area 520 and that were previously established beforehand.

The network communication manager module is executable by the one or more computer processor devices to cause the system to simply post the messages received from the users to the first and/or second areas 510, 520 for retrie3val by other users. In addition, the network communication manager module is executable by the one or more computer processor devices to cause the system to transmit the tendered messages received from the user to one or more server devices of an associated network in operative communication with the system or directly via the application pathway 107 (FIG. 1), and receive via the one or more server devices of the associated network or directly a first reply message from the targeted recipient in reply to the first tendered message.

The communication thread stitching module is executable by the one or more computer processor devices to cause the system to associate the first reply message received from the targeted recipient with the first tendered message, and based on associating the first reply message with the first tendered message, stitch the first reply message with the first tendered message linked with the selected first and second areas as dialog threads linked with the selected first and second areas 510, 520.

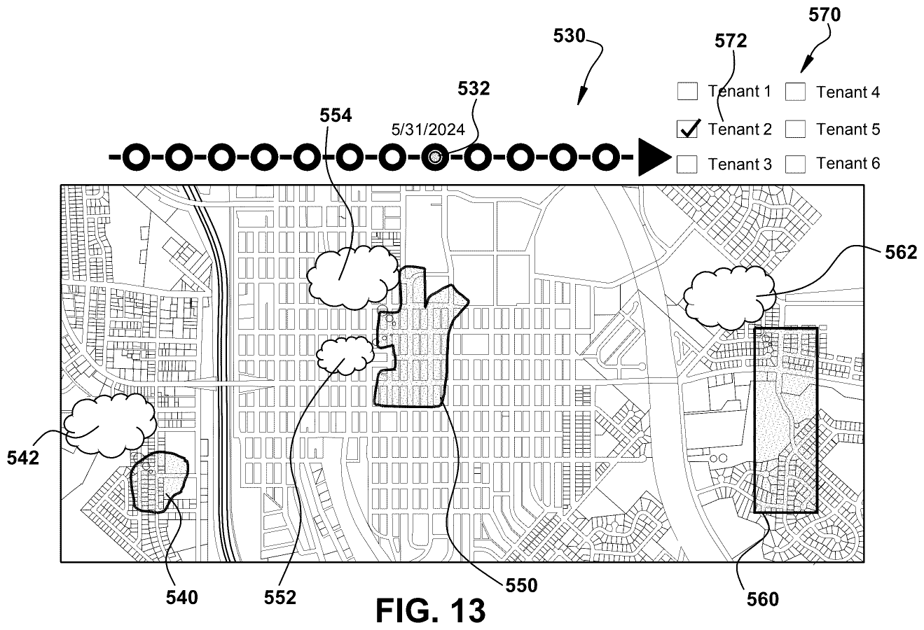

FIG. 13 is a schematic view showing a further example of information collaboration using location layers, a timeline, and specific user tenants on a map in accordance with an example embodiment. With reference now to that Figure, the map module 302 is executable by the one or more computer processor devices to cause the system to display a map 410 on a screen of an electronic device and receive a selection of a first time 532 from a timeline 530, and display and/or otherwise highlight areas 540, 550, 560 associated with a tenant 572 selected from a set of users or tenants 570. The implementation shown in the Figure may be used for real estate development collaboration on a map. In the example, the user may select other tenants whereupon the system 100 is operable to display areas associated with the selected tenant such as areas other than those 540, 550, 560 associated with the selected tenant 572.

In addition, the user may select a time from the time line 530 different from the selected time 532 for viewing messages or other information in the dialog between the user and the selected tenant at the various times along the timeline. In the example shown, the selected tenant 572 and the user at the selected time 532 along the timeline exchanged messages and/or other information related to the first highlighted area 540 as represented by the dialog bubble 542. Similarly in the example shown, the selected tenant 572 and the user at the selected time 532 along the timeline exchanged messages and/or other information related to the second highlighted area 550 as represented by the dialog bubbles 552, 554, and the selected tenant 572 and the user at the selected time 532 along the timeline exchanged messages and/or other information related to the third highlighted area 560 as represented by the dialog bubble 562.

It is to be appreciated that each of the dialogs and information and message exchanges between the user and the selected tenant 572 are mutually stitched together and linked to the respective areas 540, 550, and 560 on the map. In addition, the system 100 is operable to display the dialog from the bubbles when the user clicks or otherwise selects the desired communication bubble.

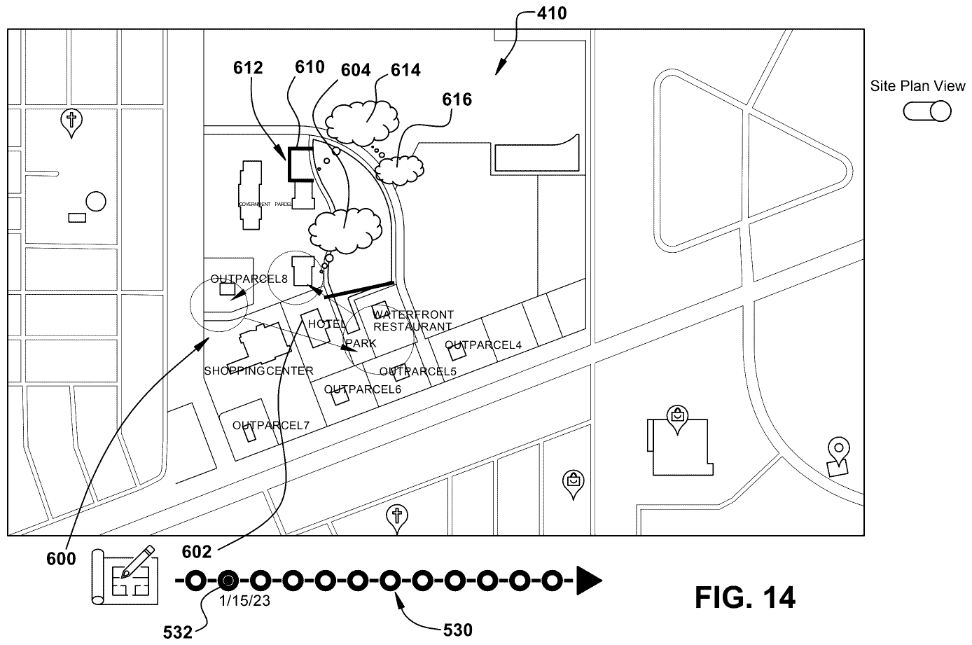

FIG. 14 is a schematic view showing a further example of information collaboration using location markup layers, and a timeline on a map in accordance with an example embodiment.

With reference now to that Figure, the map module 302 is executable by the one or more computer processor devices to cause the system to display a map 410 on a screen of an electronic device and receive a selection of a first time 532 from a timeline 530, and display and/or otherwise highlight location markups 600, 610 associated with a locations on the map. The implementation shown in the Figure may be used for real estate development collaboration on a map. In the example, the user may select other locations and or other time on the timeline 530 whereupon the system 100 is operable to display other location markups associated with the locations or times such markups to areas other than those shown the Figure.

The location markup 600 may include proposed site revision markups 602 presented by a user of the system 100. Similarly, the location markup 610 may include proposed site revision markups 612 presented by a user of the system 100.

In the example shown, the proposed site revision markups 602 may include exchanged messages and/or other information related to the highlighted area 600 as represented by the dialog bubble 604. Similarly, the proposed site revision markups 612 may include exchanged messages and/or other information related to the highlighted area 610 as represented by the dialog bubbles 614, 616.

It is to be appreciated that each of the dialogs and information and message exchanges between the users are mutually stitched together and linked to the respective areas 600, 610 on the map. In addition, the system 100 is operable to display the dialog from the bubbles when the user clicks or otherwise selects the desired communication bubble.

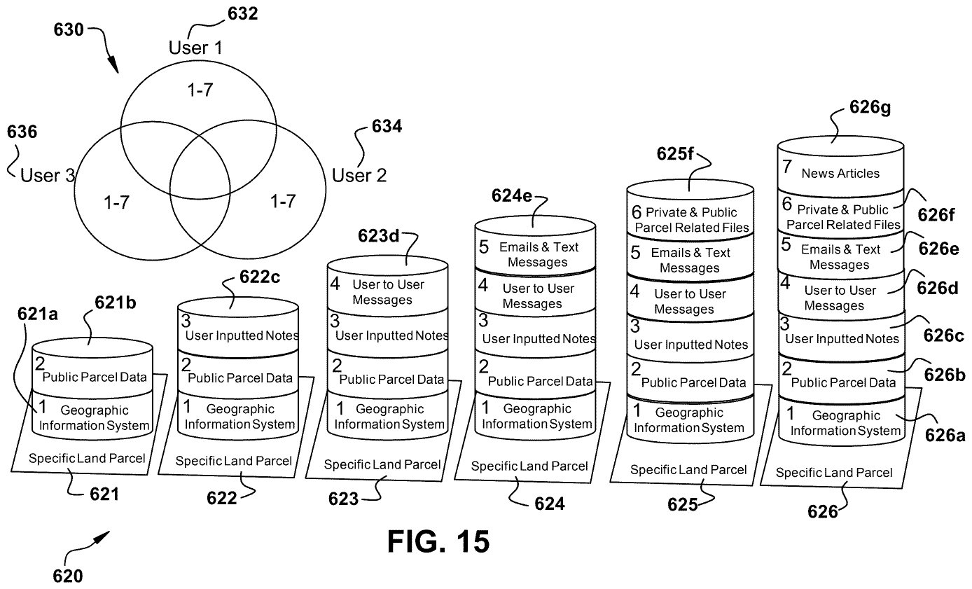

FIG. 15 is a schematic representation of layers of messages and other information that may be stitched together and linked to various locations for collaboration on a map. With reference not to that Figure, various locations 620 on the map are represented by several parcel locations 621-626, wherein various types of messages, data, and other information may be stitched together and collectively linked each of the several parcel locations 621-626.

In the example illustrated each of the several parcel locations 621-626 may include geographic information system information 621a-626a, and public parcel data 621b-626b. In the example implementation, the geographic information system information 621a is stitched with the public parcel data 621b which is in turn linked with the parcel location 621. Similarly, each of the items of geographic information system information 622a-626a is stitched with the items of public parcel data 622b-626b which are in turn linked with their respective parcel locations 622-626.

In the example illustrated some of the several parcel locations 622-626 may include user imputed note information 622c-626c. In the example implementation, the user imputed note information 622c-626c is stitched with each of the items of geographic information system information 622a-626a and with the items of public parcel data 622b-626b which are in turn linked with their respective parcel locations 622-626.

In the example illustrated some of the several parcel locations 623-626 may include user to user message data 623d-626d. In the example implementation, the user message data 623d-626d is stitched with the user imputed note information 623c-626c, and with each of the items of geographic information system information 623a-626a and with the items of public parcel data 623b-626b which are in turn linked with their respective parcel locations 623-626.

In the example illustrated some of the several parcel locations 624-626 may include email and text message data 624e-626e. In the example implementation, the email and text message data 624e-626e is stitched with the user message data 624d-626d and with the user imputed note information 624c-626c, and with each of the items of geographic information system information 624a-626a and with the items of public parcel data 624b-626b which are in turn linked with their respective parcel locations 624-626.

Further in the example illustrated some of the several parcel locations 625 and 626 may include public and private parcel related file data 625f and 626f. In the example implementation, the public and private parcel related file data 625f and 626f is stitched with the email and text message data 625e and 626e and with the user message data 625d and 626d and with the user imputed note information 625c and 626c, and with each of the items of geographic information system information 625a and 626a, and with the items of public parcel data 625b and 626b which are in turn linked with their respective parcel locations 625 and 626.

Yet still further in the example illustrated the parcel location 626 may include news article file data 626g. In the example implementation, the news article file data 626g is stitched with the public and private parcel related file data 626f, and with the email and text message data 626e and with the user message data 626d and with the user imputed note information 626c and with each of the items of geographic information system information 626a and the items of public parcel data 626b which are in turn linked with the parcel location 626.

In addition to showing a schematic representation of layers of messages and other information that may be stitched together and linked to various locations for collaboration on a map, FIG. 15 also shows in a Venn Diagram form 630 the manner in which the system 100 in accordance with an example implementation permits access to users 632, 634, 636 to the geographic information system information 621a-626a, the public parcel data 621b-626b, the user imputed note information 622c-626c, the user message data 623d-626d, the email and text message data 624e-626e, the public and private parcel related file data 625f, and the news article file data 626g that is linked to the map locations illustrated in the example as parcels 621-626.

As illustrated, each set of information linked to the map locations illustrated in the example as parcels 621-626 may be assigned by the system 100 an index number wherein the geographic information system information 621a-626a is assigned index number one (1) by the system 100, the public parcel data 621b-626b is assigned index number two (2) by the system 100, the user imputed note information 622c-626c is assigned index number three (3) by the system 100, the user message data 623d-626d is assigned index number four (4) by the system 100, the email and text message data 624e-626e is assigned index number five (5) by the system 100, the public and private parcel related file data 625f is assigned index number six (6) by the system 100, and the news article file data 626g is assigned index number seven (7) by the system 100.

In the example implementation illustrated, each of the users 632, 634, 636 are permitted by the system 100 to all levels 107 of the data and other information that is stitched together and linked to the various locations 621-626 on the map. However, it is to be appreciated that each of the users 632, 634, 636 may have access to various different levels of the data and other information that is stitched together and linked to the various locations 621-626 on the map wherein access of each user is determined and permitted and/or otherwise facilitated by the system based on the intersections of the user levels as illustrated in the Venn Diagram form 630.

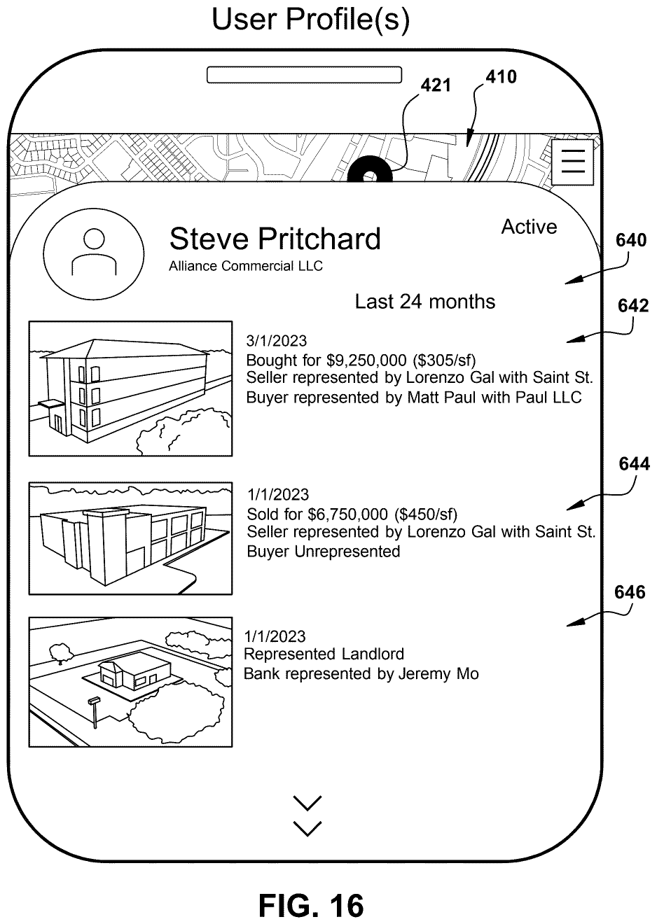

FIG. 16 shows an example of a user interface 640 illustrating system support of linking or otherwise tying user profiles to locations on a map. In an example implementation the profiles linked to the locations on a map may include for example listings, development projects, track records, and the like. In the example implementation the map module 302 is executable by the one or more computer processor devices to cause the system to receive a selection of a second location 421 of the map 410 from the user of the electronic device 110, 112, 114, and 116, and highlight the selected second location relative to the map displayed on the screen of the electronic device. The user communication manager module 304 is executable by the one or more computer processor devices to cause the system to receive a second tendered message from the user in association with the selected second location being displayed on the screen, wherein the second tendered message comprises user profile information data 642, 644, 646 associated with the user, wherein the user profile information data is representative of profile information of the user. The linking module 306 is executable by the one or more computer processor devices to cause the system to link the second tendered message comprising the user profile information data 642, 644, 646 with the selected second location 421.

In the example implementation, any user of the system 100 may view the user profile information data 642, 644, 646 associated with the user thereby helping to facilitate collaboration on the map 410. In this regard, the map module 302 is executable by the one or more computer processor devices to cause the system to receive a selection of the second location of the map from a second user of the electronic device, highlight the selected second location relative to the map displayed on the screen of the electronic device, and display the user profile information data 642, 644, 646 linked with the selected second location on the screen of the electronic device 110, 112, 114, and 116.

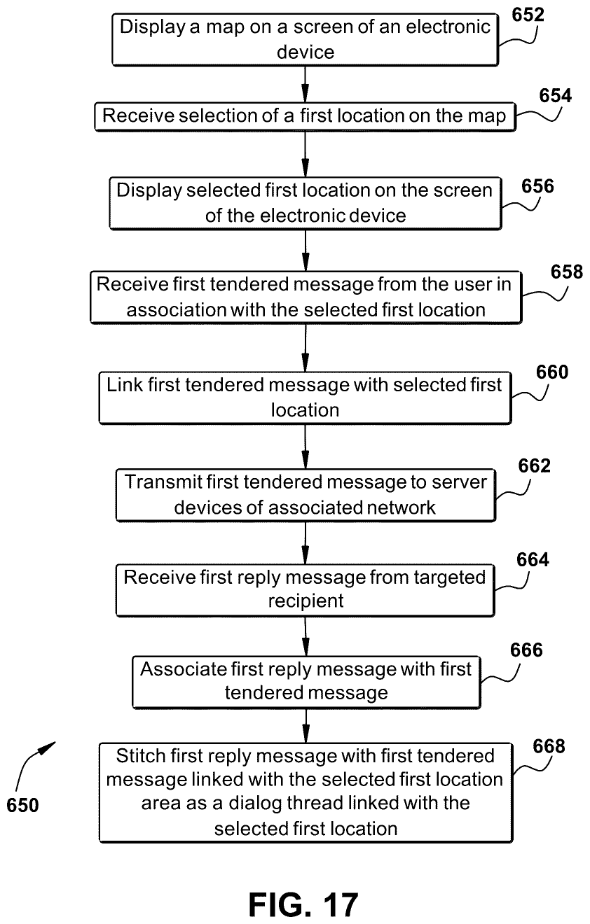

FIG. 17 illustrates an example of a method 650 of facilitating collaboration on a map in accordance with an implementation. Although processing steps, method steps or algorithms, etc. are described in order, such processes, methods and algorithms may be configured to operate in alternate orders. In other words, any order or order of steps set forth in this patent application inherently does not imply a requirement that the steps be performed in that order. The steps of the processes described may actually be performed in any order. Further, some steps are not described or shown as being performed concurrently (eg, one step is described after other steps), but may be performed concurrently. Furthermore, the processes illustrated in the figures are not meant to be interpreted as excluding other modifications and variations of the illustrated processes, nor as required for any one or more of the illustrated processes or steps thereof. It does not indicate that the treatment is preferred.

With reference now to that FIG. 17, the method 650 includes displaying at 652 a map on a screen of an electronic device 110, 112, 114, 116 comprising one or more computer processors and one or more non-transient memory devices operatively coupled with the one or more computer processors.

A selection of a first location on the map is received at 654 from the user of the electronic device and, at 656, the selected first location is displayed on the screen of the electronic device.

A first tendered message is received at 658 from the user in association with the selected first location being displayed on the screen. In accordance with an implementation, the first tendered message identifies a targeted recipient.

The first tendered message is linked at 660 with the selected first location.

The first tendered message received from the user is transmitted at 662 to one or more server devices of an associated network in operative communication with the electronic device.

A first reply message is received at 664 from the targeted recipient in reply to the first tendered message via the one or more server devices of the associated network a first reply message.

The first reply message received from the targeted recipient is associated at 666 with the first tendered message.

At 668 based on associating the first reply message with the first tendered message, the first reply message is stitched with the first tendered message linked with the selected first location as a first dialog thread linked with the selected first location.

In accordance with an implementation of the method 650 shown for example in FIG. 17, a first user 431 may be shown by the system 100 the reply 433 received from the targeted or recipient 432. In this regard the method 650 further comprises displaying the first dialog thread comprising the first reply message stitched with the first tendered message on the screen of the electronic device in association with the selected first location being displayed on the screen of the electronic device.

In accordance with a further implementation of the method 650 shown for example in FIG. 17, a first user 431 may be shown by the system 100 other user threads related to the a selected location on the map. In this regard the method 650 further comprises determining one or more other dialog threads linked with the selected first location, wherein the one or more other dialog threads comprise one or more communications related to the selected first location between one or more other users of the system different than the user of the system, and displaying on the screen of the electronic device the one or more other dialog threads in association with the selected first location being displayed on the screen of the electronic device.

In accordance with a further implementation of the method 650 shown for example in FIG. 17, a first user 431 may be shown by the system 100 other user threads related to a further different selected location on the map. In this regard the method 650 further comprises receiving a selection of a second location on the map from the user of the electronic device, displaying the selected second location on the screen of the electronic device, determining one or more other dialog threads linked with the selected second location, wherein the one or more other dialog threads comprise one or more communications related to the selected second location between one or more other users of the system different than the user of the system, and displaying on the screen of the electronic device the one or more other dialog threads in association with the selected second location being displayed on the screen of the electronic device.

In accordance with a further implementation of the method 650 shown for example in FIG. 17, the system 100 supports plural user tagging modalities, wherein the method further comprises receiving the first tendered message from the user in association with the selected first location being displayed on the screen as a first tendered message comprising a tag that identifies the targeted recipient, wherein the tag comprises one or more of a system username that identifies the targeted recipient, an email contact address that identifies the targeted recipient, a cellular phone contact number that identifies the targeted recipient, and/or a social media contact character set that identifies the targeted recipient. The method further selects an associated network in operative communication with the system based on the tag comprising the one or more of the system username, the email contact address, the cellular phone contact number, and/or the a social media contact character set, and transmitting the first tendered message to one or more server devices of the selected associated network.

In accordance with a further implementation of the method 650 shown for example in FIG. 17, the system 100 supports a public group broadcast to plural recipients, wherein the method further comprises receiving the first tendered message from the user in association with the selected first location being displayed on the screen, wherein the first tendered message comprises a user group name that identifies a plurality of targeted recipients that are associated as members of a first user group having the name, transmitting the first tendered message comprising the user group name received from the user to one or more server devices of an associated network in operative communication with the system, receiving via the one or more server devices of the associated network a plurality of first reply messages from the plurality of targeted recipient members of the first group having the name in reply to the first tendered message, associating the plurality of first reply messages received from the plurality of targeted recipients with the first tendered message, and stitching, based on associating each of the plurality of first reply messages with the first tendered message, each of the plurality of first reply messages with the first tendered message linked with the selected first location as a first group dialog thread linked with the selected first location.

In accordance with a further implementation of the method 650 shown for example in FIG. 17, the system 100 supports private group membership broadcast to plural group recipients. In this regard the method further comprises receiving the first tendered message from the user in association with the selected first location being displayed on the screen, wherein the first tendered message comprises a private user group name that identifies a plurality of targeted private group recipients that are associated as members of a first private user group having the private user group name, receiving via the one or more server devices of the associated network a plurality of first reply messages from the targeted private group of recipients in reply to the first tendered message, associating the plurality of first reply messages received from the targeted group of recipients with the first tendered message, stitching, based on associating each of the plurality of first reply messages with the first tendered message, each of the plurality of first reply messages with the first tendered message linked with the selected first location as a first private group dialog thread linked with the selected first location, and preventing displaying on the screen of the electronic device the first private group dialog thread to users of the system other than users identified by the private user group name as being members of the targeted private group of recipients.

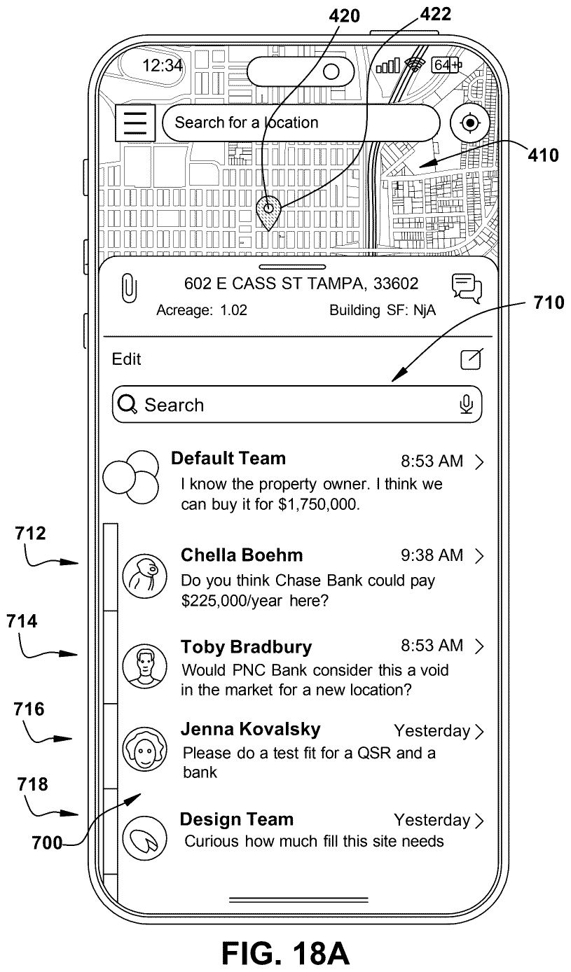

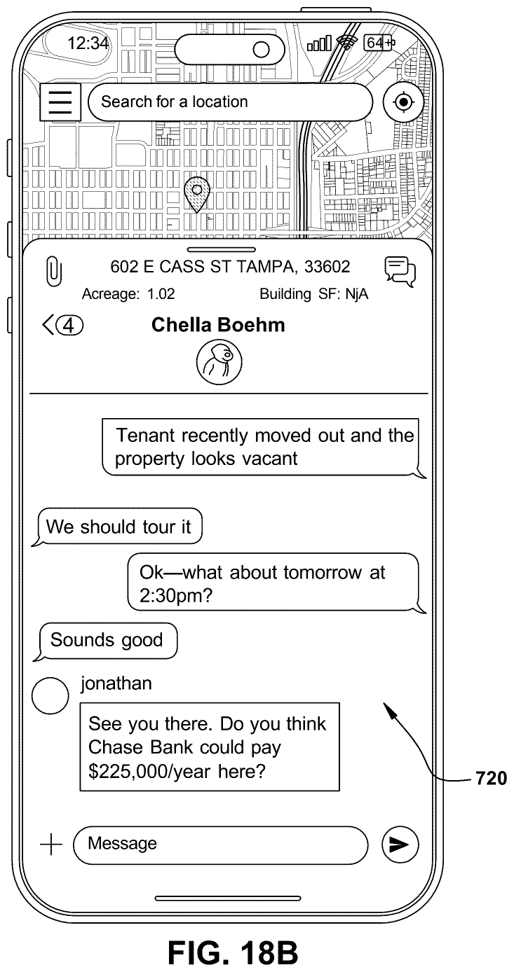

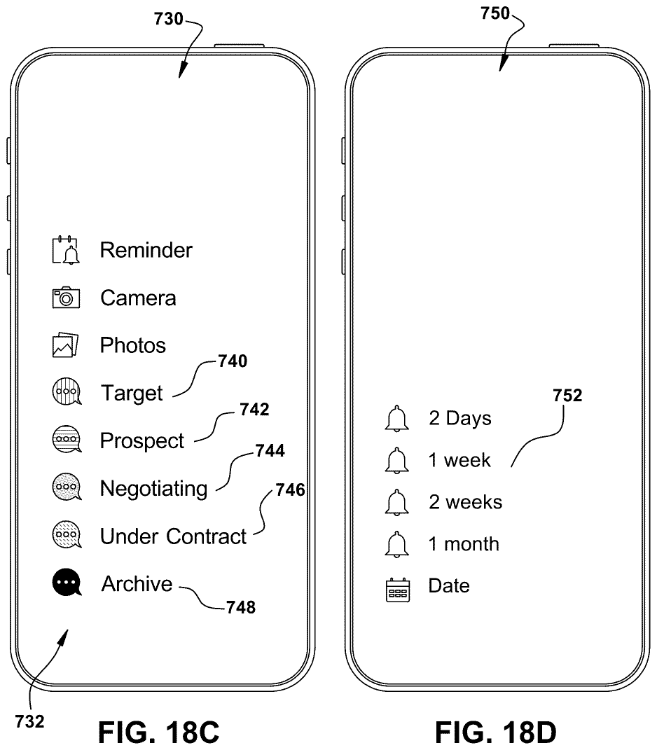

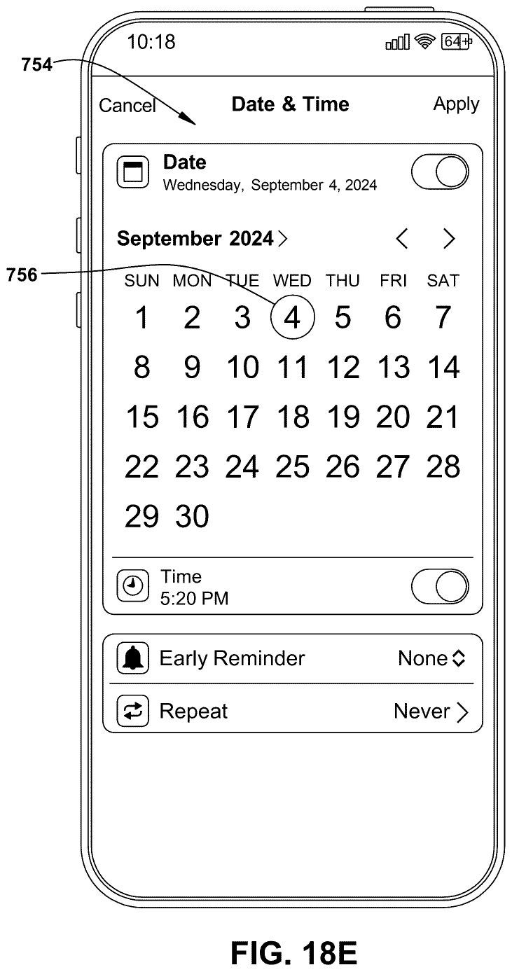

FIGS. 18A-18E show examples of a user interface 700 illustrating system support of workflow management on a map in accordance with an example embodiment. The map module 302 (FIG. 3) is executable by the one or more computer processor devices 204 (FIG. 2) to cause the system to display a map 410 on a screen of an electronic device, receive a selection of a first location 420 of the map 410 from a user of the electronic device and highlight 422 the selected first location 420 relative to the map displayed on the screen of the electronic device. A workflow warehousing module 312 (FIG. 3) is executable by the one or more computer processor devices 204 (FIG. 2) to cause the system to identify stored task items 710 associated with the user based on the map module receiving the selection of the first location. In the example illustrated, the stored task items 710 are recollections of conversation threads 712-718 by and between various users of the system 100 and in relation to the selected first location 420. In an implementation, the conversation threads 712-718 by and between various users of the system 100 were previously each respectively stitched together and each previously linked to the selected first location 420.

The system 100 (FIG. 1) is executable by the one or more computer processor devices 204 (FIG. 2) to cause the system to display a dialog window 720 as shown in FIG. 18B for receiving messages and other information from the user of the system for communicating with one or more other users of the system relating to the selected first location 420.

In addition, the system 100 (FIG. 1) is executable by the one or more computer processor devices 204 (FIG. 2) to cause the system to display a further dialog window 730 as shown in FIG. 18C for receiving from the user of the system task activity type qualifiers 732 that include in the example a target activity type 740 representative of the identified location being subject of interest for sale, purchase, or lease by one or more users of the system, a prospect activity type 742 representative of the identified location being available for purchase and/or lease, a negotiating activity type 744 representative of the identified location being involved in ongoing sale, purchase, or lease negotiations, an active under contract activity type 746 representative of the identified location being under contract for sale, purchase, or lease, or under construction, and/or an archive activity type 748 representative of the identified location being inactive relative to sale, purchase, or lease interest or activities.

It is to be appreciate that FIGS. 18A-18E show example user interfaces illustrating system support of workflow management on a map in accordance with an example embodiment, and that the user interfaces shown there and described herein are exemplary only, and that the interface is customizable so that users may easily and quickly implement their own distinct and/or unique categories, such as “Stages 1-15” or the like for example, in place of or in addition to the Target (740), Prospect (742), Negotiating (744), Under Contract (746), and Archive (748) categories shown and described herein.

In addition, the system 100 (FIG. 1) is executable by the one or more computer processor devices 204 (FIG. 2) to cause the system to display a further dialog window 750 as shown in FIG. 18D for receiving from the user of the system calendaring information 752 to be assigned for follow-up in connection with the one or more conversation threads 712-718 by and between various users of the system 100 were previously each respectively stitched together and each previously linked to the selected first location 420. The further dialog window 750 as shown in FIG. 18D may also be used for receiving from the user of the system calendaring information 752 to be assigned for follow-up in connection with the messages and other information received from the user of the system via the dialog window 720 as shown in FIG. 18B.

In further addition, the system 100 (FIG. 1) is executable by the one or more computer processor devices 204 (FIG. 2) to cause the system to display a still further dialog window 754 as shown in FIG. 18E for receiving from the user of the system refined calendaring information 756 to be assigned for follow-up in connection with the one or more conversation threads 712-718 by and between various users of the system 100 were previously each respectively stitched together and each previously linked to the selected first location 420. The further dialog window 754 as shown in FIG. 18E may also be used for receiving from the user of the system the further refined calendaring information 756 to be assigned for follow-up in connection with the messages and other information received from the user of the system via the dialog window 720 as shown in FIG. 18B.

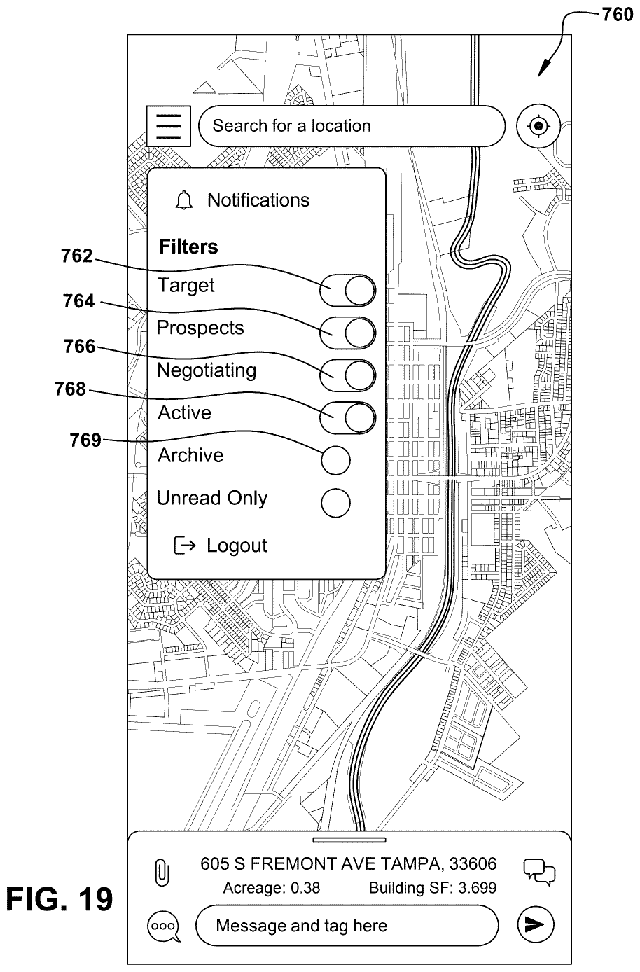

FIG. 19 shows an example of a user interface 760 illustrating system support of filtering workflow management on a map in accordance with an example embodiment wherein the map 410 presented to the user is filtered by the system 100 to display to the user map indicia 416 (FIG. 4) and in particular virtual pin indicia 418 corresponding to selection by the user of the one or more system task activity type qualifiers 732 described above. In the example implementation the system 100 is operable to display to the user only map indicia 416 (FIG. 4) and in particular only virtual pin indicia 418 corresponding to locations subject of interest for sale, purchase, or lease by one or more users of the system in response to selection by the user of the target activity type 740 task activity type qualifiers 732 using a target activity toggle button or other indicia 762.

Similarly, the system 100 is operable to display to the user only map indicia 416 (FIG. 4) and in particular only virtual pin indicia 418 corresponding to locations available for purchase and/or lease in response to selection by the user of the prospect activity type 742 task activity type qualifiers 732 using a prospect activity toggle button or other indicia 76.

Also similarly, the system 100 is operable to display to the user only map indicia 416 (FIG. 4) and in particular only virtual pin indicia 418 corresponding to locations involved in ongoing sale, purchase, or lease negotiations in response to selection by the user of the negotiating activity type 744 task activity type qualifiers 732 using a negotiating activity toggle button or other indicia 766.

Still also similarly, the system 100 is operable to display to the user only map indicia 416 (FIG. 4) and in particular only virtual pin indicia 418 corresponding to locations under contract for sale, purchase, or lease, or under construction in response to selection by the user of the active under contract activity type 746 task activity type qualifiers 732 using an active under contract toggle button or other indicia 768.

Further also similarly, the system 100 is operable to display to the user only map indicia 416 (FIG. 4) and in particular only virtual pin indicia 418 corresponding to locations inactive relative to sale, purchase, or lease interest or activities in response to selection by the user of the archive activity type 748 task activity type qualifiers 732 using an archive activity toggle button or other indicia 769.

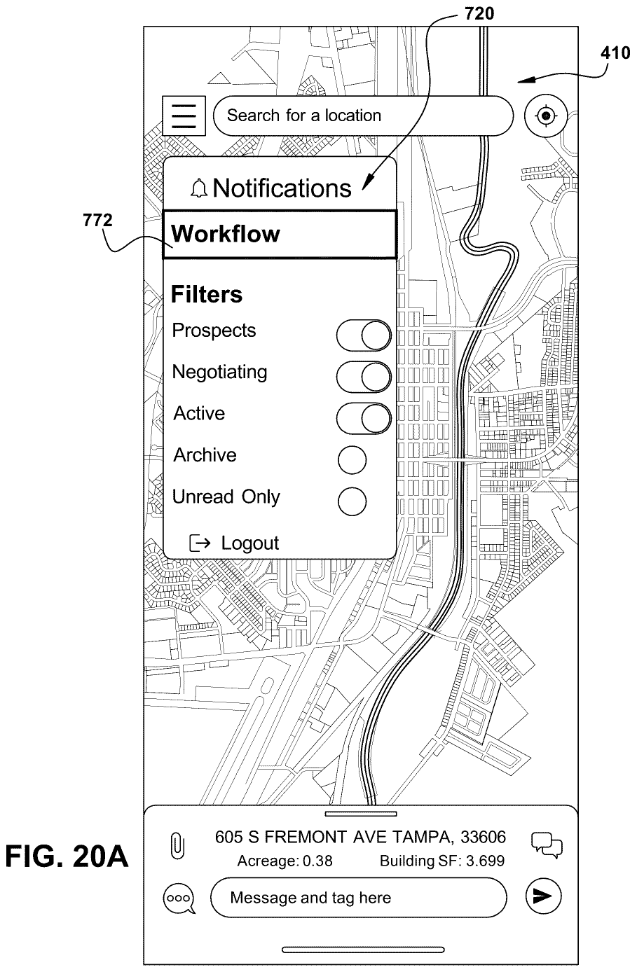

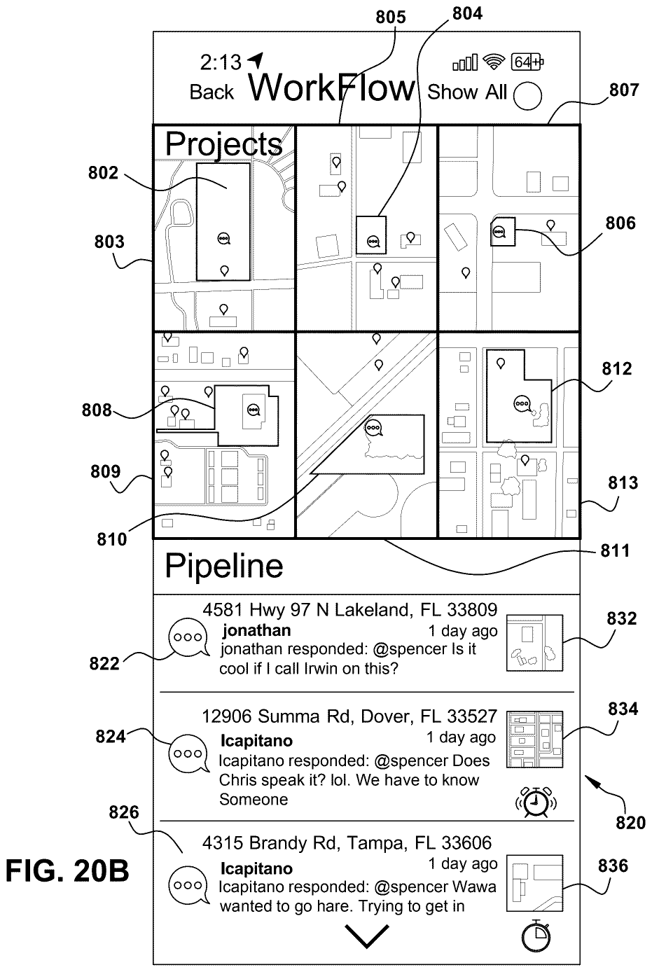

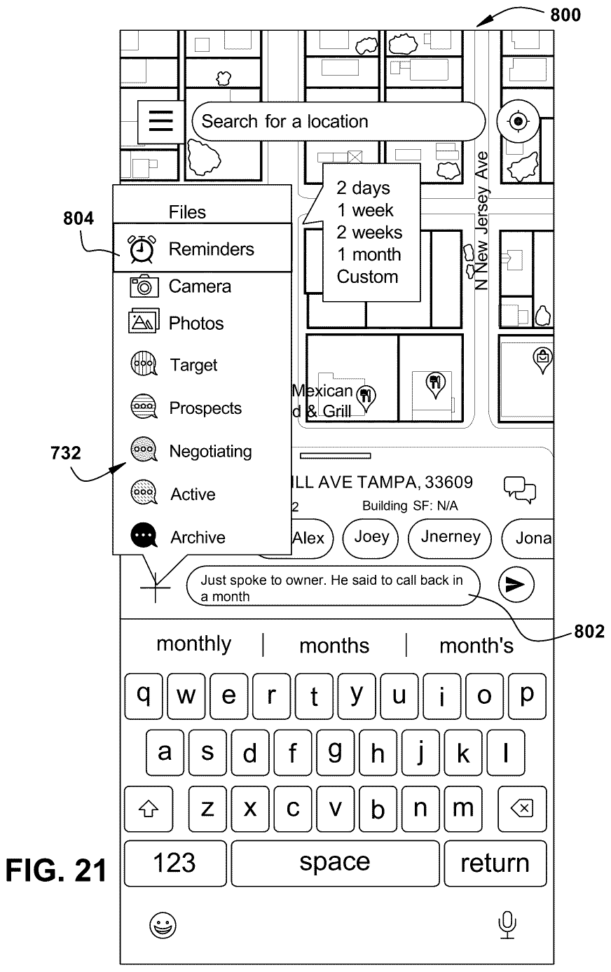

In accordance with the implementations herein, the task items may be projects and/or pipelines tasks such as for example messaging task items. FIGS. 20A and 20B show example user interfaces illustrating system support of project and pipeline workflow management on a map in accordance with an example embodiment. In this regard, the map module 302 (FIG. 3) of the system 100 is executable by the one or more computer processor devices 204 (FIG. 2) to cause the system 100 to display a map together with a set of management initiation buttons or other indicia on a screen of an electronic device, and receive from a user of the electronic device a selection of a workflow management initiation button or other indicia 772 from among the set of management initiation buttons or other indicia 770.

A workflow warehousing module 312 (FIG. 3) of the system 100 is executable by the one or more computer processor devices 204 (FIG. 2) to cause the system 100 to identify a stored task item associated with the user based on the map module receiving the selection of the workflow management initiation button or other indicia from the user.

The linking module 306 of the system 100 is executable by the one or more computer processor devices 204 (FIG. 2) to cause the system 100 to identify a location on the map previously linked by the linking module with the stored task item identified by the workflow warehousing module as being associated with the user, wherein the map module is executable by the one or more computer processor devices to cause the system to display on the map the identified location linked with the stored task item.

As mentioned, in accordance with the implementations herein, the task items may be projects and/or pipelines tasks such as for example messaging task items. In accordance with an implementation wherein the task items are projects 800, the map module 302 is executable by the one or more computer processor devices to cause the system to display on the screen of the electronic device the identified stored project task items as marker image overlays 802, 804, 806, 808, 810, 812 on the identified location on the map.

The map module 302 is executable by the one or more computer processor devices to cause the system to display on the screen of the electronic device the identified stored project task item as a marker image having visual representations 803, 805, 807, 809, 811, 813 of the activity types of the identified stored project task item.

In accordance with an implementation, the map module 302 is executable by the one or more computer processor devices to cause the system to display on the screen of the electronic device the identified stored project task item as a marker image having a different visual color and/or pattern representation of the one or more different activity types. In this regard the system 100 is operative to display in different colors the target activity type, the prospect activity type, the negotiating activity type, the active activity type, and the archive activity type.

As mentioned, in accordance with the implementations herein, the task items may be projects and/or pipelines tasks such as for example messaging task items. In accordance with an implementation wherein the task items are pipeline tasks 825 such as for example messaging task items, the map module 302 is executable by the one or more computer processor devices to cause the system to display on the screen of the electronic device messaging task items 822, 824, 826 as images of text comprising the identified stored messaging task item in proximate association with the locations 832, 834, 836 on the map linked with the stored task items.

In accordance with a further implementation, a curator warehousing module 314 (FIG. 3) of the system 100 is executable by the one or more computer processor devices 204 (FIG. 2) to cause the system 100 to curate the identified stored messaging task item to the user from a plurality of historical message dialogs relative to a plurality of locations on the map based on a predetermined set of parameters.

In accordance with a further implementation, the messaging task items comprising the projects 800 and message pipelines 826 are curated to the user in accordance with one or more protocols. In this regard, the curator warehousing module 314 is executable by the one or more computer processor devices to cause the system to curate the identified stored messaging task item to the user from the plurality of historical message dialogs relative to the plurality of locations on the map based on one or more of message tagging events associated with the user, stored message reminder events associated with the user, keyword detection in the plurality of historical message dialogs, and/or an inactivity of messaging events related to the user.

With regard to the tagging events portion of the task curator protocol the logical function iterates over all tagging events related to the user and the specific marker. A multiplier is applied based on how recently the event occurred within I day: Multiplier of 2.0; within 7 days: Multiplier of 1.5, older than 7 days: Multiplier of 1.0. Thereafter, each tagging event contributes 5 points multiplied by the time multiplier to the final score.

With regard to the reminder events portion of the task curator protocol, the logical function loops through reminder events, applying the same time-based multiplier. Thereafter, each reminder event contributes 10 points multiplied by the time multiplier to the final score.

With regard to the poke events portion of the task curator protocol, the logical function evaluates poke events in the same way as tagging and reminders. Thereafter, the contribution of each poke event is 7 points multiplied by the time multiplier to the final score.

With regard to the keyword detection in conversations portion of the task curator protocol, the messages in conversations associated with the marker and the user are scanned for specific keywords. Thereafter, points are assigned based on the keyword detected according to: “need”: 3 points; “left vm”, “texted”: 2 points; “?”: 2 points; “sent”, “submitted”: 3 points; and “idk”: 4 points. Thereafter, each keyword detection contributes points based on the time multiplier.

With regard to the inactivity on red pins portion of the task curator protocol, the logical function checks the last activity timestamp for red pins associated with the user and marker. Thereafter, points are added based on the number of weeks since the last activity according to: 4 or more weeks: 30 points; 3 weeks: 20 points; and 2 weeks: 15 points. Thereafter, the points are added directly to the final score based on weeks of inactivity.

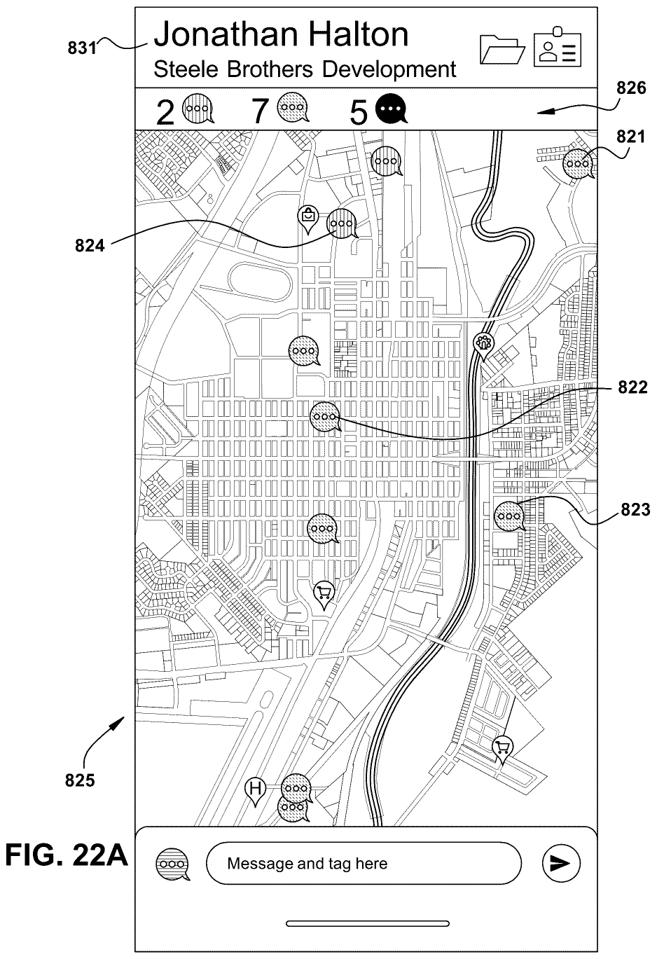

FIG. 21 shows an example of a user interface 800 illustrating system support of filtering and reminder workflow management on a map in accordance with an example embodiment. With reference not to that Figure, the system 100 is operable to provide an interface 800 to the user that includes a dialog area 802 adapted to receive a message from the user. The message may be annotated by receiving from the user of the system one or more task activity type qualifiers 732 that include in the example a target activity type 740 representative of the identified location being subject of interest for sale, purchase, or lease by one or more users of the system, a prospect activity type 742 representative of the identified location being available for purchase and/or lease, a negotiating activity type 744 representative of the identified location being involved in ongoing sale, purchase, or lease negotiations, an active under contract activity type 746 representative of the identified location being under contract for sale, purchase, or lease, or under construction, and/or an archive activity type 748 representative of the identified location being inactive relative to sale, purchase, or lease interest or activities.

The message may be further annotated by receiving from the user of the system a reminder selection 804 for the user to be reminded to follow-up any messages or the like entered into the dialog box 802 in accordance with the example implementations discussed above.

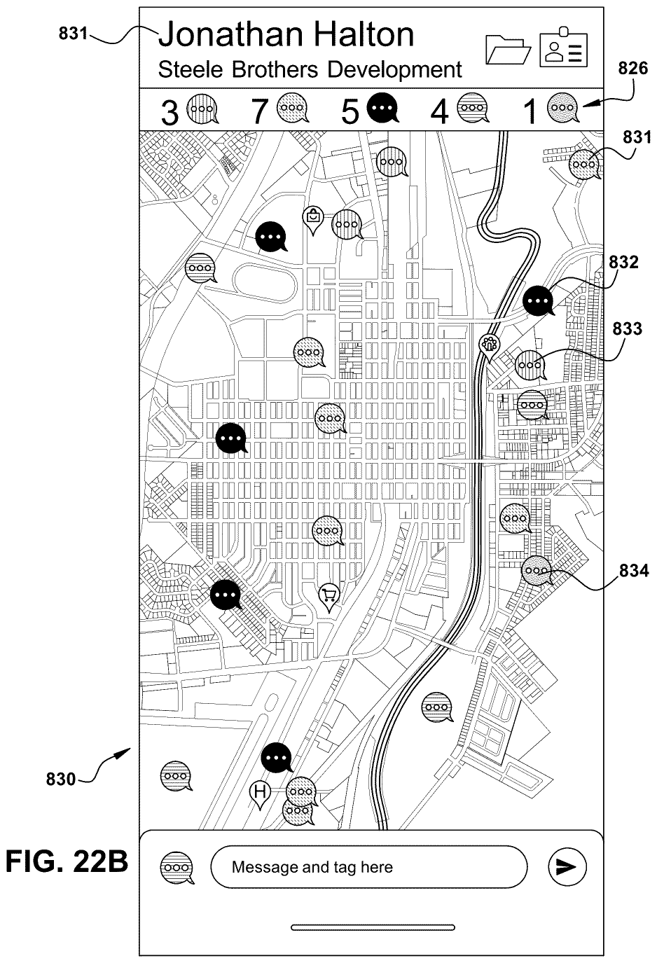

FIGS. 22A and 22B show example user interfaces illustrating system support of public and private publication of user profiles linked to locations on a map in accordance with an example embodiment. FIG. 22A shows an example of a user interface 820 illustrating system support of linking or otherwise tying a public user profile of a user 431 to locations 821, 822, 823, 824 on a map. Similarly, FIG. 22BA shows an example of a user interface 830 illustrating system support of linking or otherwise tying a private user profile of the user 431 to locations 831, 832, 833, 834 on a map.

In accordance with an implementation, each of the public and private profiles linked to the various locations on the map may be associated with or otherwise stitched together with an activity type 740 representative of the identified location being subject of interest for sale relative to the user 431, purchase, or lease by one or more users of the system relative to the user 431, a prospect activity type 742 representative of the identified location being available for purchase and/or lease relative to the user 431, a negotiating activity type 744 representative of the identified location being involved in ongoing sale relative to the user 431, purchase, or lease negotiations, an active under contract activity type 746 representative of the identified location being under contract for sale, purchase, or lease, or under construction relative to the user 431, and/or an archive activity type 748 representative of the identified location being inactive relative to sale, purchase, or lease interest or activities relative to the user 431.

The user profiles may be provided to showcase digitally the footprint of the user on the map/market, as desired. Inclusive of past projects and track records, notes, current projects/opportunities/listings, and prospective sites. The system 100 in accordance with an implementation is operable to create a medium for more serendipitous communication and subsequent deal flow. This advantageously requires less time required to connect data points. In this way, users may showcase future, current, and past deals, projects, and the like to both public (FIG. 22A) and private (FIG. 22B) markets.

In the example implementation the map module 302 is executable by the one or more computer processor devices to cause the system to receive a selection of a second location 421 of the map 410 from the user of the electronic device 110, 112, 114, and 116, and highlight the selected second location relative to the map displayed on the screen of the electronic device. The user communication manager module 304 is executable by the one or more computer processor devices to cause the system to receive a second tendered message from the user in association with the selected second location being displayed on the screen, wherein the second tendered message comprises user profile information data 642, 644, 646 associated with the user, wherein the user profile information data is representative of profile information of the user. The linking module 306 is executable by the one or more computer processor devices to cause the system to link the second tendered message comprising the user profile information data 642, 644, 646 with the selected second location 421.

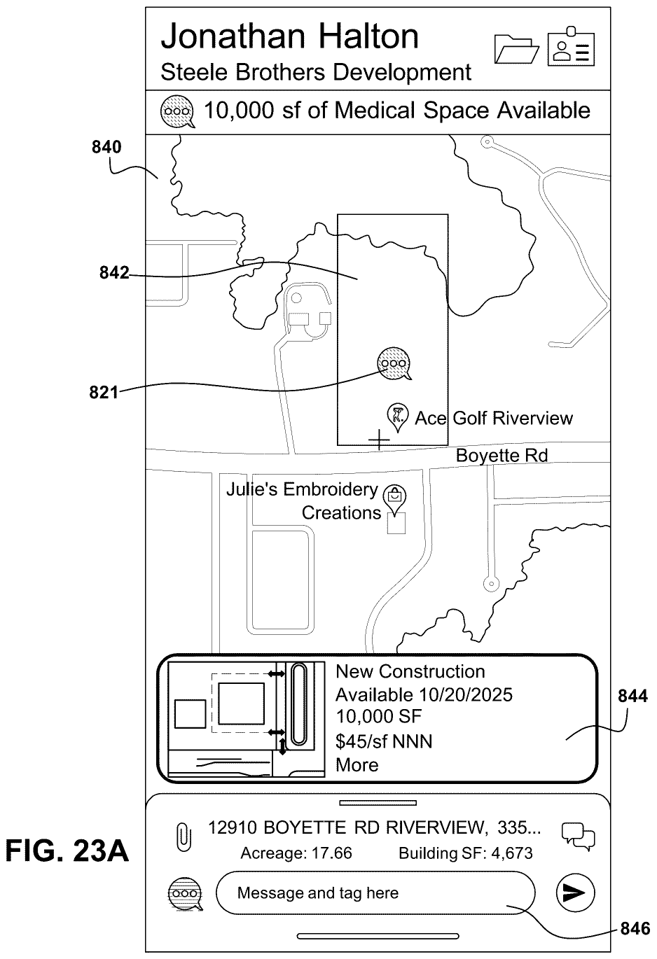

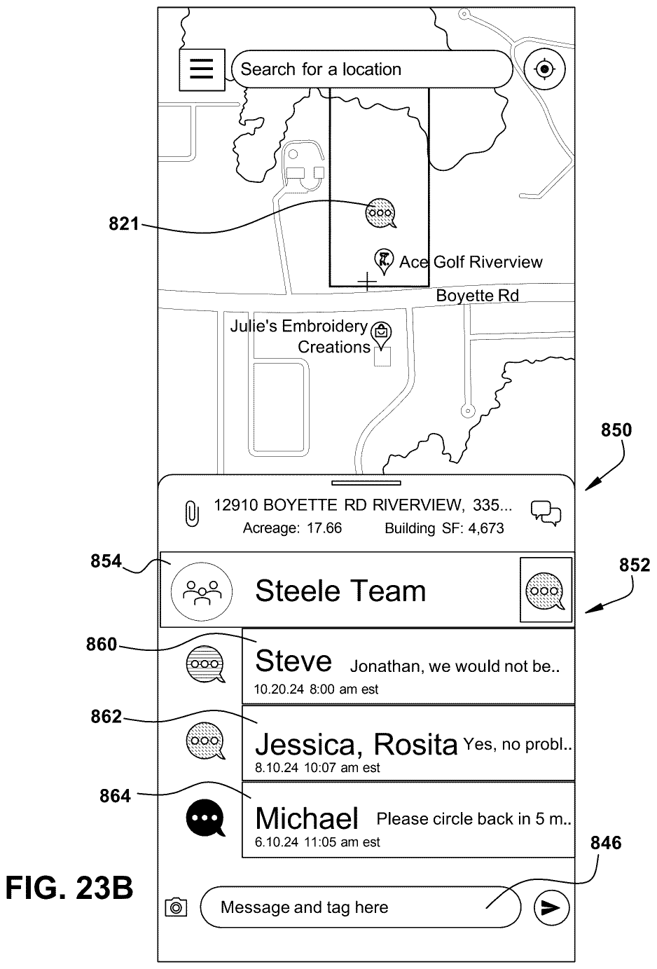

FIG. 23A shows an example of a user interface 840 illustrating system support of public and private publication of user profiles linked to locations on a map based on either of the interfaces of FIG. 22A or 22B in accordance with an example embodiment. A user may select location 821 from the interface 820 of FIG. 22A whereupon the system is operable to display the user interface 840 that shows the selected location 821 in an enlarged view on the map and that also includes a highlighted outline image 842 of the selected location 821, and other commercial information 844 for possible relationship management on the map and relative to the location 821 selected from the user interface 820 (FIG. 22A) illustrating the public user profile of a user 431 to locations 821, 822, 823, 824 on the map.

FIG. 23B shows an example of a user interface 850 based on the interface 840 of FIG. 23A illustrating stitched conversation threads 852 having different mutual interaction authorization capabilities linked to a location 821 on a map. The system 100 in accordance with an implementation is operable to receive from the user messages, data, and other information from the user via a dialog box 846. In an implementation, the various message threads may be isolated from each other to establish and maintain private conversations amongst individuals or credentialed groups of individuals as necessary or desired. For example users who are members of the group Steele Team are provided by the system 100 with option to see all communication between any individual team member as well as to see all communication linked to the location the map by and between non-team members such as for example the users 860, 862, 864.

In this example, the user of the one or more user devices 110, 112, 114, and 116 has communication directly with the first user 860 (Steve), separately with the second users 862 (Jessica and Rosita), and separately with a third user 864 (Michael). In the implementation, any member of the users group may be presented by the system 100 with all of his communication.

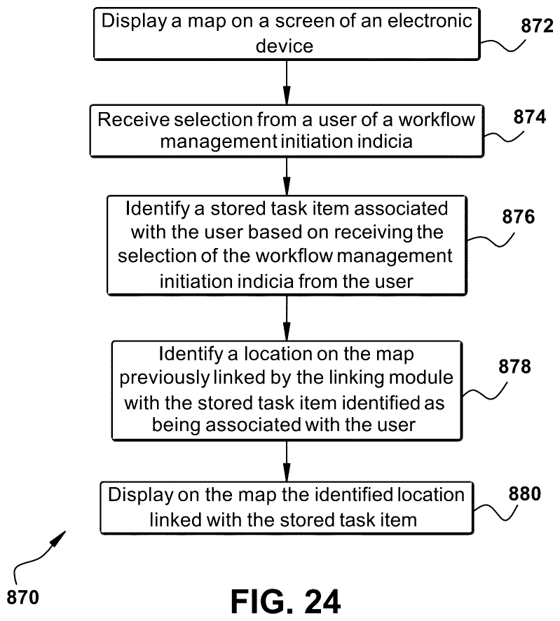

FIG. 24 illustrates an example of a method 870 for facilitating workflow management on a map in accordance with an example embodiment. Although processing steps, method steps or algorithms, etc. are described in order, such processes, methods and algorithms may be configured to operate in alternate orders. In other words, any order or order of steps set forth in this patent application inherently does not imply a requirement that the steps be performed in that order. The steps of the processes described may actually be performed in any order. Further, some steps are not described or shown as being performed concurrently (eg, one step is described after other steps), but may be performed concurrently. Furthermore, the processes illustrated in the figures are not meant to be interpreted as excluding other modifications and variations of the illustrated processes, nor as required for any one or more of the illustrated processes or steps thereof. It does not indicate that the treatment is preferred.

With reference now to that FIG. 24, the method 870 includes displaying at 872 a map on a screen of an electronic device comprising one or more computer processors and one or more non-transient memory devices operatively coupled with the one or more computer processors.

The method 870 further includes receiving at 874 from a user of the electronic device a selection of a workflow management initiation indicia from among the set of management initiation indicia displayed on the screen of the electronic device.

The method 870 further includes identifying at 876 a stored task item associated with the user based on receiving the selection of the workflow management initiation indicia from the user.

The method 870 further includes identifying at 878 a location on the map previously linked by the linking module with the stored task item identified as being associated with the user.

The method 870 further includes displaying at 880 on the map the identified location linked with the stored task item.

It is to be understood that other embodiments and/or implementations will be utilized and structural and functional changes will be made without departing from the scope of the present disclosure. The foregoing descriptions of embodiments of the present example implementations have been presented for the purposes of illustration and description. It is not intended to be exhaustive or to limit the invention to the precise forms disclosed. Accordingly, many modifications and variations are possible in light of the above teachings. It is therefore intended that the scope of this disclosure and of the claims appended below not be limited by this detailed description.

1. A system facilitating collaboration on a map, the system comprising:
one or more computer processors; and
one or more non-transient memory devices operatively coupled with the one or more computer processors, the one or more non-transient memory devices storing computer executable instructions that when executed by the one or more computer processor devices cause the system to facilitate the collaboration on the map, wherein the executable instructions comprise:
a map module executable by the one or more computer processor devices to cause the system to:
display a map on a screen of an electronic device;
receive a selection of a first location of the map from a user of the electronic device; and
highlight the selected first location relative to the map displayed on the screen of the electronic device;
a user communication manager module executable by the one or more computer processor devices to cause the system to:
receive a first tendered message from the user in association with the selected first location being displayed on the screen, wherein the first tendered message identifies a targeted recipient;
a linking module executable by the one or more computer processor devices to cause the system to:
link the first tendered message with the selected first location;
a network communication manager module executable by the one or more computer processor devices to cause the system to:
transmit the first tendered message received from the user to one or more server devices of an associated network in operative communication with the system;
receive via the one or more server devices of the associated network a first reply message from the targeted recipient in reply to the first tendered message; and
a communication thread stitching module executable by the one or more computer processor devices to cause the system to:
associate the first reply message received from the targeted recipient with the first tendered message; and
based on associating the first reply message with the first tendered message, stitch the first reply message with the first tendered message linked with the selected first location as a first dialog thread linked with the selected first location.

2. The system according to claim 1, wherein:
the map module is executable by the one or more computer processor devices to cause the system to:
display the first dialog thread comprising the first reply message stitched with the first tendered message on the screen of the electronic device in association with the selected first location being displayed on the screen of the electronic device.

3. The system according to claim 1, wherein:
the communication thread stitching module is executable by the one or more computer processor devices to cause the system to:
determine one or more other dialog threads linked with the selected first location, wherein the one or more other dialog threads comprise one or more communications related to the selected first location between one or more other users of the system different than the user of the system; and
the map module is executable by the one or more computer processor devices to cause the system to:
display on the screen of the electronic device the one or more other dialog threads in association with the selected first location being displayed on the screen of the electronic device.

4. The system according to claim 1, wherein:
the map module is executable by the one or more computer processor devices to cause the system to:
receive a selection of a second location of the map from the user of the electronic device; and
display the selected second location on the screen of the electronic device;
the communication thread stitching module is executable by the one or more computer processor devices to cause the system to:
determine one or more other dialog threads linked with the selected second location, wherein the one or more other dialog threads comprise one or more communications related to the selected second location between one or more other users of the system different than the user of the system; and
the map module is executable by the one or more computer processor devices to cause the system to:
display on the screen of the electronic device the one or more other dialog threads in association with the selected second location being displayed on the screen of the electronic device.

5. The system according to claim 1, wherein:
the user communication manager module is executable by the one or more computer processor devices to cause the system to:
receive the first tendered message from the user in association with the selected first location being displayed on the screen as a first tendered message comprising a tag that identifies the targeted recipient, wherein the tag comprises one or more of:
a system username that identifies the targeted recipient;
an email contact address that identifies the targeted recipient;
a cellular phone contact number that identifies the targeted recipient; and/or
a social media contact character set that identifies the targeted recipient; and
the network communication manager module is executable by the one or more computer processor devices to cause the system to:
select an associated network in operative communication with the system based on the tag comprising the one or more of the system username, the email contact address, the cellular phone contact number, and/or the a social media contact character set; and
transmit the first tendered message to one or more server devices of the selected associated network.

6. The system according to claim 1, wherein:
the user communication manager module is executable by the one or more computer processor devices to cause the system to:
receive the first tendered message from the user in association with the selected first location being displayed on the screen, wherein the first tendered message comprises a user group name that identifies a plurality of targeted recipients that are associated as members of a first user group having the name;
the network communication manager module is executable by the one or more computer processor devices to cause the system to:
transmit the first tendered message comprising the user group name received from the user to one or more server devices of an associated network in operative communication with the system; and
receive via the one or more server devices of the associated network a plurality of first reply messages from the plurality of targeted recipient members of the first group having the name in reply to the first tendered message;
the communication thread stitching module is executable by the one or more computer processor devices to cause the system to:
associate the plurality of first reply messages received from the plurality of targeted recipients with the first tendered message; and
based on associating each of the plurality of first reply messages with the first tendered message, stitch each of the plurality of first reply messages with the first tendered message linked with the selected first location as a first group dialog thread linked with the selected first location.

7. The system according to claim 1, wherein:
the user communication manager module is executable by the one or more computer processor devices to cause the system to:
receive the first tendered message from the user in association with the selected first location being displayed on the screen, wherein the first tendered message comprises a private user group name that identifies a plurality of targeted private group recipients that are associated as members of a first private user group having the private user group name;
the network communication manager module is executable by the one or more computer processor devices to cause the system to:
receive via the one or more server devices of the associated network a plurality of first reply messages from the targeted private group of recipients in reply to the first tendered message;
the communication thread stitching module is executable by the one or more computer processor devices to cause the system to:
associate the plurality of first reply messages received from the targeted group of recipients with the first tendered message; and
based on associating each of the plurality of first reply messages with the first tendered message, stitch each of the plurality of first reply messages with the first tendered message linked with the selected first location as a first private group dialog thread linked with the selected first location; and
the map module is executable by the one or more computer processor devices to cause the system to:
prevent displaying on the screen of the electronic device the first private group dialog thread to users of the system other than users identified by the private user group name as being members of the targeted private group of recipients.

8. The system according to claim 1, wherein:
the map module is executable by the one or more computer processor devices to cause the system to:
receive a selection of a second location of the map from the user of the electronic device; and
highlight the selected second location relative to the map displayed on the screen of the electronic device;
the user communication manager module is executable by the one or more computer processor devices to cause the system to:
receive a second tendered message from the user in association with the selected second location being displayed on the screen, wherein the second tendered message comprises user profile information data associated with the user, wherein the user profile information data is representative of profile information of the user;
the linking module is executable by the one or more computer processor devices to cause the system to:
link the second tendered message comprising the user profile information data with the selected second location.

9. The system according to claim 8, wherein:
the map module is executable by the one or more computer processor devices to cause the system to:
receive a selection of the second location of the map from a second user of the electronic device;
highlight the selected second location relative to the map displayed on the screen of the electronic device; and
display the user profile information data linked with the selected second location on the screen of the electronic device.

10. A method of facilitating collaboration on a map, the method comprising:
displaying a map on a screen of an electronic device comprising one or more computer processors and one or more non-transient memory devices operatively coupled with the one or more computer processors;
receiving from a user of the electronic device a selection of a first location on the map;
displaying the selected first location on the screen of the electronic device;
receiving a first tendered message from the user in association with the selected first location being displayed on the screen, wherein the first tendered message identifies a targeted recipient;
linking the first tendered message with the selected first location;
transmitting the first tendered message received from the user to one or more server devices of an associated network in operative communication with the electronic device;
receiving via the one or more server devices of the associated network a first reply message from the targeted recipient in reply to the first tendered message;
associating the first reply message received from the targeted recipient with the first tendered message; and
stitching, based on associating the first reply message with the first tendered message, the first reply message with the first tendered message linked with the selected first location as a first dialog thread linked with the selected first location.

11. The method according to claim 10, further comprising:
displaying the first dialog thread comprising the first reply message stitched with the first tendered message on the screen of the electronic device in association with the selected first location being displayed on the screen of the electronic device.

12. The method according to claim 10, further comprising:
determining one or more other dialog threads linked with the selected first location, wherein the one or more other dialog threads comprise one or more communications related to the selected first location between one or more other users of the system different than the user of the system; and
displaying on the screen of the electronic device the one or more other dialog threads in association with the selected first location being displayed on the screen of the electronic device.

13. The method according to claim 10, further comprising:
receiving a selection of a second location on the map from the user of the electronic device;
displaying the selected second location on the screen of the electronic device;
determining one or more other dialog threads linked with the selected second location, wherein the one or more other dialog threads comprise one or more communications related to the selected second location between one or more other users of the system different than the user of the system; and
displaying on the screen of the electronic device the one or more other dialog threads in association with the selected second location being displayed on the screen of the electronic device.

14. The method according to claim 10, further comprising:
receiving the first tendered message from the user in association with the selected first location being displayed on the screen as a first tendered message comprising a tag that identifies the targeted recipient, wherein the tag comprises one or more of:
a system username that identifies the targeted recipient;
an email contact address that identifies the targeted recipient;
a cellular phone contact number that identifies the targeted recipient; and/or
a social media contact character set that identifies the targeted recipient;
selecting an associated network in operative communication with the system based on the tag comprising the one or more of the system username, the email contact address, the cellular phone contact number, and/or the a social media contact character set; and
transmitting the first tendered message to one or more server devices of the selected associated network.

15. The method according to claim 10, further comprising:
receiving the first tendered message from the user in association with the selected first location being displayed on the screen, wherein the first tendered message comprises a user group name that identifies a plurality of targeted recipients that are associated as members of a first user group having the name;
transmitting the first tendered message comprising the user group name received from the user to one or more server devices of an associated network in operative communication with the system;
receiving via the one or more server devices of the associated network a plurality of first reply messages from the plurality of targeted recipient members of the first group having the name in reply to the first tendered message;
associating the plurality of first reply messages received from the plurality of targeted recipients with the first tendered message; and
stitching, based on associating each of the plurality of first reply messages with the first tendered message, each of the plurality of first reply messages with the first tendered message linked with the selected first location as a first group dialog thread linked with the selected first location.

16. The method according to claim 8, further comprising:
receiving the first tendered message from the user in association with the selected first location being displayed on the screen, wherein the first tendered message comprises a private user group name that identifies a plurality of targeted private group recipients that are associated as members of a first private user group having the private user group name;
receiving via the one or more server devices of the associated network a plurality of first reply messages from the targeted private group of recipients in reply to the first tendered message;
associating the plurality of first reply messages received from the targeted group of recipients with the first tendered message;
stitching, based on associating each of the plurality of first reply messages with the first tendered message, each of the plurality of first reply messages with the first tendered message linked with the selected first location as a first private group dialog thread linked with the selected first location; and
preventing displaying on the screen of the electronic device the first private group dialog thread to users of the system other than users identified by the private user group name as being members of the targeted private group of recipients.

17. The method according to claim 10, further comprising:
receiving a selection of a second location of the map from the user of the electronic device;
highlighting the selected second location relative to the map displayed on the screen of the electronic device;
receiving a second tendered message from the user in association with the selected second location being displayed on the screen, wherein the second tendered message comprises user profile information data associated with the user, wherein the user profile information data is representative of profile information of the user; and
linking link the second tendered message comprising the user profile information data with the selected second location.

18. The method according to claim 17, further comprising:
receiving a selection of the second location of the map from a second user of the electronic device;
highlighting the selected second location relative to the map displayed on the screen of the electronic device; and
displaying the user profile information data linked with the selected second location on the screen of the electronic device.

19. A non-transient computer readable storage medium storing one or more computer programs comprising instructions that, when executed by one or more processor devices of an associated computer system, cause the associated computer system to perform a method of facilitating collaboration on a map, the method comprising:
displaying a map on a screen of an electronic device comprising one or more computer processors and one or more non-transient memory devices operatively coupled with the one or more computer processors;
receiving from a user of the electronic device a selection of a first location on the map;
displaying the selected first location on the screen of the electronic device;
receiving a first tendered message from the user in association with the selected first location being displayed on the screen, wherein the first tendered message identifies a targeted recipient;
linking the first tendered message with the selected first location;
transmitting the first tendered message received from the user to one or more server devices of an associated network in operative communication with the electronic device;
receiving via the one or more server devices of the associated network a first reply message from the targeted recipient in reply to the first tendered message;
associating the first reply message received from the targeted recipient with the first tendered message; and
stitching, based on associating the first reply message with the first tendered message, the first reply message with the first tendered message linked with the selected first location as a first dialog thread linked with the selected first location.

20. The non-transient computer readable storage medium according to claim 19, wherein the method further comprises:
displaying the first dialog thread comprising the first reply message stitched with the first tendered message on the screen of the electronic device in association with the selected first location being displayed on the screen of the electronic device.
